(19) United States
(12) Patent Application Publication
(10) Pub. No.: US 2011/0282727 A1
(43) Pub. Date: Nov. 17, 2011

(54) CONTENT MANAGEMENT IN OUT-OF-HOME ADVERTISING NETWORKS

(76) Inventors: Minh Phan, Laguna Hills, CA (US); Douglas Q. Woo, Hermosa Beach, CA (US); John Araki, Tustin, CA (US)

(21) Appl. No.: 12/780,168

(22) Filed: May 14, 2010

(51) Int. Cl. G06Q 30/00; G06K 7/10; G06K 19/06

(52) U.S. Cl. 705/14.36; 705/14.4; 235/375; 705/14.49; 705/14.1

(57) ABSTRACT

A system and method for delivering advertising and non-advertising content includes a content management system for receiving content, editing received content (if necessary), storing content, and scheduling content for display in display systems.

### BACKGROUND OF THE INVENTION

1. Field of the Invention

The present invention relates to out-of-home advertising networks that display programming using digital signage, and more particularly to improved processes for content acquisition and management in such networks.

2. Description of the Related Art

The present invention relates to the field of integrated publication of programming such as user generated content in “out-of-home” digital media networks. Out-of-home digital media networks are like private television channels run by companies, organizations and advertisers in locations such as shopping malls, retail chains, or franchise operations. Such networks are sometimes also referred to as location-based or narrow-cast networks, because unlike broadcast media, they are designed to appeal to the audience at or close to a specific location. Out-of-home digital media networks incorporate digital signage, a form of electronic display (such as LCD, LED, plasma displays, or projected images) that shows information, advertising and other messages.

Digital out-of-home media networks are sometimes described in three main segments. The first segment is location based networks, in environments like transit stations, restaurants and bars, office buildings, doctor's offices, etc. These locations include one or multiple screens in venues that offer opportunities to view and often present the highest consumer dwell time. The second segment is retail, in which screens are positions at key locations within retail environments such as shopping aisles and check-outs. The third segment is outdoor OOH networks, in which medium-to-large format screens replace traditional outdoor billboards.

One application of out-of-home digital media networks is out-of-home advertising, in which the narrow-cast networks control the display of advertising. Typical out-of-home advertising presents advertising along with other content such as news and entertainment. Out of home advertising presents marketing to consumers when they are “on the go” in public places, in transit, waiting (such as in a doctor's office) or in commercial locations such as in retail venues. One example of out of home advertising is gasoline station advertising, in which traditional signs placed above gasoline pumps have been replaced with gasoline pump topper digital displays that present advertising and other content while consumers fill up their cars with gasoline.

In considering the opportunities and challenges of out-of-home advertising, it is helpful to compare the use of digital signage as an advertising medium with traditional advertising media, and with the Internet. Traditionally, brand promoters have reached the target audience for their brands by advertising in mass media such as print media, television, or radio. Over time, brand promoters learned that certain types of people tended to watch certain types of television shows. As a result, brand promoters began to purchase commercial time from media that tended to fit the target demographic for the brand or product being promoted.

In recent years, the emergence of the Internet as an important communications medium has produced new opportunities for brand promoters. Over time, owners and operators of websites that served advertisements have deployed more effective technology solutions that allowed brand promoters advertising on their sites to reach their target audiences. One solution that has become popular is the use of contextual based advertising. Contextual adserving systems assess a number of variables, such as the text on the web page, to determine which ads to serve on the page. The most relevant advertisement for the content of the page is served.

In addition, so-called behavioral ad serving systems have been developed that take into account not only the content of the web page, but also the viewer of the web page. Using behavioral ad-serving technology, the emphasis is placed not only on the content but an analysis of the viewer of the content. These types of systems typically evaluate the viewer's past online actions and pages viewed, often through the use of cookies or some other tracking technology.

Like advertising on the Internet, the use of narrow-cast digital media networks provides special opportunities and challenges for network operators and brand promoters. Advertising techniques developed for the internet will not necessarily carry over to out-of-home advertising using digital signage. Internet technologies such as web pages, mark-up languages and hyper linking are not generally available on digital signage. This fact makes it more difficult to measure advertising audiences, since unlike web pages out-of-home advertising is not interactive, and advertising mechanisms such as visitor-tracking technologies and “click-throughs” are unavailable.

The goal of engaging the advertising audience often involves the effective combination of advertising with non-advertising content. Internet technologies such as page markup and style sheets, and web content aggregation techniques such as portals and mashups, are not available when narrow-casting programming via digital signage.

Out-of-home advertising is gaining advertisers' attention in the current environment of fragmentation of media and a decline in the power of traditional mass media. Traditional forms of advertising have become less and less effective in reaching consumers fragmented over hundreds of channels and with the introduction of new methods of delivering programming. The internet, mobile telephony, and digital signage are three increasingly widespread programming delivery technologies. These developments in new digital media are playing out through experimentation with all forms of content, notably including user generated content.

The term “user generated content” has entered mainstream usage to refer to various kinds of media content that are produced by end-users and are publicly available. This term gained currency in the fields of web publishing and new media content production. The rise of user generated content follows from the expansion of media production through new digital media technologies that are accessible and affordable to the general public.

Common types of media content encompassed by this category include for example blogging, digital video, podcasting, mobile phone photography and wikis.

Another term sometimes used interchangeably with user generated content is “social media”. Social media use tools that provide users the ability to create links and trackbacks that foster and describe their trust relationships. Trust relationships can arise from the dedication of individual publishers. Additionally, social media permit links to be established between publishers. Social media can be contrasted to industrial media commonly referred to as “traditional”, “broadcast” or “mass” media. Industrial media are associated with specialized means of production owned privately or by government, whereas social media tools are generally available to anyone at little or no cost.

To date, brand promoters have has limited success in leveraging current ad-serving technologies to associate their brands with user generated content and social networking websites. One reason for this failure is that major brand owners have significant value at risk when associating their brands with content of any sort. Millions of dollars are spent carefully crafting brand messages in order to build intangible corporate assets. For this reason, brand owners are particularly careful about the content with which consumers will associate their brands, and the association of brands with user generated content can present a higher degree of risk to the brands than more traditional types of content. Just as with advertising on the Internet, combining user generated content with advertising in narrow-cast digital media networks provides special challenges. Social media present significant potential synergies between brands and user generated content, on the one hand, and potential damage to brand image on the other.

Out-of-home digital media networks are aligned with industrial or traditional media in the networks' use of specialized means of production (proprietary networks and digital signage) that are owned privately. On the other hand, because they are designed to appeal to an audience at or close to a specific location, out-of-home digital media networks share attributes with community media. Community media use both social and industrial media frameworks. The present invention adapts the tools of out-of-home digital media networks to localized programming such as social media or user generated content, in order to take advantage of a dimension of community that permits the publication of programming to be location-centric.

Another limitation of traditional out-of-home media network is that their processes for acquiring and managing content, and managing their network display inventory, have been largely manual. For example, content is typically received by email or on disk, manually posted to the network, and manually reformatted if required for network compatibility. Likewise processes for creating network playlists, and managing advertising inventory, traditionally are largely manual.

### Notes on Prior Art

Software suites have been developed for use under license by out-of-home advertising networks. Scala, Inc. is the producer of the Scala5 digital signage software suite, which includes modules to create dynamic content, manage and distribute content, and play back distributed content). See www.scala.com. Scala does not use or teach applicants' automated techniques for acquiring, managing, and playing multimedia (content items), and for managing network inventory.

Another digital signage software suite is TELentice Enterprise, which was developed by Fujitsu Australia. See http://www.fujitsu.com/au/services/solutions/telentice/. TELentice's web site states that its service “centrally stores and transmits digital media across IP (Internet Protocol) networks, including wireless. The system can be used to schedule and display any kind of digital multimedia” and that these multimedia can be “transmitted to a wide range of PCs, plasma screens, LCD screens, mobile phones, PDAs, Point-of-Sale displays, kiosks, ATMs and Web sites”. However, TELentice Enterprise does not provide the precise three-dimensional program wheel control over display of content of the present inventors' IMS system nor does TELentice Enterprise use or teach applicants' automated techniques for acquiring, managing, and playing multimedia (content items), and for managing network inventory.

Another category of prior art is systems for publishing user generated content in out-of-home digital media networks. “Prius Neighborhood” (event.gstv.com/) is a venture of Gas Station TV and Toyota Motor Sales USA, comprising a website and television show that presents specialized programming. The programming comprises consumer-generated community relations announcements about local events. The Gas Station TV out-of-home advertising network generates listings on at-the-pump screens while presenting advertising about the Toyota Prius. In addition, Prius Neighborhood posts user events to FACEBOOK and TWITTER pages sponsored by this venture. While Prius Neighborhood combines user generated content with advertising in an out-of-home advertising network, it does not permit users to order a placement of their UGC on the narrow-cast network nor to request scheduling or additional services.

Another commercial system for publishing user generated content on out-of-home digital media networks is Wiffiti (developed by the Somerville, Mass. software firm LocaModa). See http://wiffiti.com/. Wiffiti is relevant to features such as narrowcasting user generated content, sourcing e-signage content from handheld devices, and tagging content e.g. integrated messaging themes that relate TWITTER micro blog posts (tweets) to other content.

U.S. Pat. No. 7,450,954 (assigned to LocaModa, sponsor of the Wiffiti service) teaches a system in which user messages may be sent to specific location-based screens via mobile communication devices or the Internet. The location-based screens are display devices that are connected to a central content server such as a central website. Communications are controlled by a first network with an Internet-connected screen that can view and/or create content for any or all specific locations. A handheld device such as a mobile phone or personal digital assistant (PDA) can transmit and to receive messages to the central content server via a second network, for example a wireless telephone network. The '954 patent does not address the issues of integrating user generated content into out-of-home advertising, and does not permit users to order placement of user generated content in an out-of-home advertising network based upon an inventory of locations and play schedule.

Danoo (www.danoo.com) is a location-based media network headquartered in San Francisco. Danoo owns and operates a digital out-of-home advertising network in high dwell-time locations such as health clubs, airport newsstands, airline seatback TVs, and coffeehouses, delis and cafes. www.danoo.com/participate is a web page that permits users to request placement of information on local events.

A further user-oriented digital signage network is the El Segundo, Calif. company Ripple (http://www.ribbletv.com). Ripple describes itself as an interactive network of screens located in community gathering places.

A number of companies have used digital billboards at a location such as a stadium or arena, to display SMS messages from audience members. As an example, fans were able to send messages of encouragement by SMS to their favorite athletes during the course of the Paris Saint-Denis World Athletic Championships in August 2003. The messages were alternately displayed on two giants screen in the stadium. Designed to entertain audiences during a show, these applications do not support data for or from consumers at other locations, either physical (such as other arenas) or virtual (such as websites). Also, being event-centric, such applications are by default, one-off events, and therefore miss the opportunity to provide a time-lapse view of data sent to the same location over time which can add an interesting and social dimension to the data.

Companies have developed applications using a single screen or bank of screens in a single location such as a lobby, able to respond to email, Instant Messages (IM) or SMS messages. This type of application provides information or entertainment for visitors or staff. These applications do not involve networking among a plurality of locations.

Interactive billboards that communicate with handheld devices are described by U.S. Pat. No. 5,835,861, and require handheld devices to have wireless technologies such as Bluetooth or Infra Red (IR), as well as normal wireless capabilities. These technologies are frequently implemented in non-standard ways, creating incompatibilities between the billboard and the handheld device. With IR, the user needs line-of-sight alignment of device with transceiver, which is not ideal in an outside environment.

Just as location-based broadcasting is a signature feature of out-of-home digital media networks, localization also is a key capability of certain websites. The website EveryBlock (http://www.everyblock.com) filters an assortment of local news by location to enable users to keep track of local events, down to a “hyper local” level (block by block). Information tracked by EveryBlock includes e.g. civic information, news articles and blog entries, and entertaining content from the Web. Another hyper local news and content provider is Outside.in (http://outside.in).

### SUMMARY OF THE INVENTION

The present invention addresses the challenge of integrating programming—advertising and non-advertising content—in out-of-home advertising via digital signage. Different ad-serving technology is required in narrow-cast networks than is used in websites in order to provide contextual and behavioral advertising systems. The invention provides out-of-home advertising techniques that combine ad-serving with serving other content using a narrow-cast network server. These techniques integrate advertisements with news, entertainment, and other non-advertising content to better engage viewers and enhance the impact of the programming presented.

The improved Out of Home Advertising network (“OOH network”) of the invention permits network customers and other third party content providers to exchange content items with the OOH network over an Internet Protocol (IP) network. The OOH network includes a Datapuller that acts as client in client-server exchanges of a content file that is posted by a content provider at a server device. The server device includes an automated sales program that guides the content provider in placing an order, i.e. insertion of a content item within an inventory of play slots, thereby scheduling display of the content item at one or more OOH network location. The inventory of display slots is reserved for this purpose.

The present invention includes techniques for automating various basic functions of content acquisition and content management. Preferably, the network sales and inventory management functions are automated. At least one OOH network interface automatically offers reserved inventory to a user (content provider), and automatically inserts the user's content item in inventory in response to an order placed by the user. Other functions for processing user content items may also be automated in appropriate cases, including content ingest (filtering) and content reformatting.

In one embodiment, the OOH network includes an inventory module that tracks inventory slots (also called play slots), each comprising a given scheduled time period for playing content items and a given OOH network location. The automated sales program can permit a content provider to place an order to play a content item at a desired scheduled time period and desired OOH network location. The sales program confirms the availability of the requested play slot in inventory; available play slots are reserved play slots that were not previously ordered. The sales program inserts the content item in inventory in response to the order by the content provider.

In another embodiment network programming comprises a program wheel that is played repeatedly during a given scheduled time period at a given OOH network location. The program wheel is divided into a series of time segments within the duration of the program wheel. When using multi-zone OOH network displays, the program wheel includes a series of time segments for each of the display zones. In this embodiment an inventory slot preferably comprises not only the given scheduled time period and given OOH network location, but also a given time segment and given display zone within the program wheel. When the inventory slot is ordered for a content item, during the repeated play of the program wheel the content item is played at the given time segment and given display zone. In this embodiment, the inventory of play slots may correspond to a given display zone and one or several given time segments within the program wheel.

The server device may comprise a handheld device such as a mobile phone, which includes a smart phone (a mobile phone offering advanced capabilities, typically with PC-like functionality). The user interface may comprise a series of screens of a content posting program installed on the handheld device. Alternatively the server device may comprise a personal computer or other device that accesses a content posting web site of the OOH network, and the content posting web site may display a series of web pages. These program screens or web pages guide the content provider in posting and scheduling a content item to the OOH network.

The present invention further comprises a method for user interaction with an Out of Home Advertising network (“OOH network”) comprising a network of gas stations with gas pump topper display screens. A user at a gas pump topper display screen has a handheld device including an electronic visual display. The user interaction method includes the steps of displaying on the gas topper display screen a benefit item and access information for communicating with the OOH network using the handheld device; using the access information with the handheld device to display a network screen on the electronic visual display; and sending the benefit item to the handheld device in response to a user input to the network screen.

Benefit items may include items having economic value, such as discounts or coupons for advertiser goods and services advertised on the OOH network. Benefit items also include information for accessing advertised goods or services or other benefits displayed on a topper display screen, such as a local address or route map, or local contact information. A further type of benefit items is applications and services of the OOH network, such as an application for posting user generated content on the OOH network. Particularly attractive benefit items are those that are relevant and immediate to gas station customers, i.e. items that can be used at the pump, at an attached convenience store, or at a nearby business establishment (local advertiser).

The access information enables a gas station customer to communicate with the OOH network and receive the benefit item during limited user dwell time at a gas pump, typically around five minutes. In one embodiment, the gas station hosts a wireless local area network (WLAN) that is open to customers of the gas station, i.e. a “hot spot”. The access information can include logon instructions for the WLAN, which may direct the user to a captive portal of the OOH network.

In another embodiment, the access information comprises a bar code on the gas topper display screen, such as a two dimensional bar code that can be scanned using a mobile phone camera. When the user scans the bar code with a camera of the handheld device, the handheld device accesses an OOH network screen such as a web page. This mode of accessing the OOH network does not require the user to be logged into the gas station's WLAN.

The method of the invention may include the additional step for new users of displaying a network screen such as a web page for user registration with the OOH network. The method of the invention also may include the additional step for return users of displaying a network screen such as a web page for user entry of additional user profile information in order to receive benefit items targeted to user preferences.

In a further embodiment, the step of displaying a benefit item and access information comprises displaying the benefit item at one zone of the gas topper display screen, and simultaneously displaying the access information at another zone of the display screen, in a multi-zone display format. For example, in a three zone display screen one zone may display an advertisement including a benefit item from a local advertiser, another zone may display a route map from the gas station to the local advertiser's establishment; and a third zone may display the access information.

In another embodiment, a content management database of the OOH network stores user profile information submitted to the OOH network using the handheld device. The user profile can include demographic and psychographic information used by the OOH network in targeted advertising Benefit items may be targeted based upon the user profile information. The gas pump topper display screen may display targeted programming, for example in response to the user's entry of a display screen identification number into the handheld device.

In another embodiment, the OOH network includes a primary network of gas stations with gas pump topper display screens, and a secondary network of in-store display screens within at least some convenience stores associated with a plurality of the gas stations. Benefit items can include coupon, discounts and promotions for goods and services offered by convenience stores.

According to an aspect of the invention, a method of advertising includes the steps of: receiving non-advertising content from one or more third parties; processing in an automated matter the non-advertising content, wherein the automated processing prepares the content on an advertising display; and displaying on the display both advertising content and the processed non-advertising content.

According to another aspect of the invention, a method of advertising includes the steps of: providing a display for displaying advertising content; prompting a viewer of the display to make an input; and selecting the advertising content to be displayed on the display, as a function of the input.

According to yet another aspect of the invention, a method of advertising includes the steps of: sensing one or more viewer characteristics, using a sensing device; selecting advertising content based on the one or more viewer characteristics; and displaying the advertising content on a display device that is operatively coupled to the sensing device.

According to still another aspect of the invention, a display system includes: a display with plural display zones; and a content management module operatively coupled to the display, wherein the content management module includes a content library that stores content items. The content management module creates program wheels of the content items to be shown in the display zones of the display.

According to a further aspect of the invention, a method of allocating content slots for a display device having a plurality of display zones includes the steps of: associating content items in a content library with aspects of displaying; and scheduling display of content items on the display, wherein the content items are selected from content items in the content library based on one or more of the aspects.

According to another aspect of the invention, a method of user placement of a content item for play on a location-based out of home advertising network includes the steps of: providing a plurality of display screens each in a distinct geographic location, wherein each display screen plays content items during scheduled time periods, and wherein the content items include advertising content items and non-advertising content items; maintaining on a network server of the out of home advertising network an inventory that includes inventory slots, wherein each inventory slot includes a given display screen location and a given scheduled time period, and wherein each inventory slot may be assigned a content item ordered to play at the given display screen location and a given scheduled time period; receiving at the network server a user request from a user's electronic communications device to place a user content item in the out of home advertising network; and operating a network user interface of the network to receive the user request, to automatically determine one or more inventory slot that is available to be ordered, and to automatically place an insertion order for the user content item from the user request into at least one inventory slot.

According to still another aspect of the invention, a method for user interaction with a location-based out of home advertising network includes the steps of: displaying on a display screen that is part of the network a benefit item and access information for communicating with the OOH network using a handheld device of a user, wherein the handheld device includes en electronic visual display; sending a network screen to the handheld device, to be displayed on the electronic visual display of the handheld device, in response to use of the access information; and sending the benefit item to the handheld device in response to a user input to the network screen.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

Annexed are drawings depicting one or more embodiments of the invention. The drawings are not necessarily to scale.

FIG. 1A is a block diagram of an internal management system in accordance with an embodiment of the present invention.

FIG. 1B is a schematic diagram of an OOH network in accordance with an embodiment of the present invention.

FIG. 2 is a block diagram illustrating components/functions of a master report module of a sales module of the internal management system of FIG. 1A.

FIG. 3 is a block diagram illustrating components/functions of a sales support module of a sales module of the internal management system of FIG. 1A.

FIG. 4 is a diagram showing functions of the internal management system.

FIG. 5 is a block diagram of a content management module of the internal management system.

FIG. 6 is a first example of a zoned display used with systems and methods according to an embodiment of the present invention.

FIG. 7 is a second example of a zoned display used with systems and methods according to an embodiment of the present invention.

FIG. 8 is a third example of a zoned display used with systems and methods according to an embodiment of the present invention.

FIG. 9 is a chart illustrating a program wheel used with systems and methods in according to an embodiment of the present invention.

FIG. 10 is a chart illustrating another program wheel used with systems and methods in according to an embodiment of the present invention.

FIG. 11 is a screen shot of a first screen of a handheld device application in accordance with an embodiment of the present application.

FIG. 12 is a screen shot of a second screen of a handheld device application in accordance with an embodiment of the present application.

FIG. 13 is a screen shot of a third screen of a handheld device application in accordance with an embodiment of the present application.

FIG. 14 is a screen shot of a fourth screen of a handheld device application in accordance with an embodiment of the present application.

FIG. 15 is a screen shot of a fifth screen of a handheld device application in accordance with an embodiment of the present application.

FIG. 16 is a screen shot of a sixth screen of a handheld device application in accordance with an embodiment of the present application.

FIG. 17 is a screen shot of a seventh screen of a handheld device application in accordance with an embodiment of the present application.

FIG. 18 is a screen shot of an eighth screen of a handheld device application in accordance with an embodiment of the present application.

FIG. 19 is a screen shot of a ninth screen of a handheld device application in accordance with an embodiment of the present application.

FIG. 20 is a screen shot of a tenth screen of a handheld device application in accordance with an embodiment of the present application.

FIG. 21 is a screen shot of an eleventh screen of a handheld device application in accordance with an embodiment of the present application.

FIG. 22 is a first flow diagram of the handheld device application.

FIG. 23 is a second flow diagram of the handheld device application.

FIG. 24 is a flow chart of a process for posting content items and metadata to an OOH network, in accordance with an embodiment of the invention.

FIG. 25 is a block diagram of a content management module in accordance with another embodiment of the present invention.

FIG. 26 is a conceptual diagram showing various components for viewer interaction or viewer sensing, for use in systems and methods in accordance with an embodiment of the invention.

FIG. 27 is a screen shot showing one aspect of another embodiment of the present invention.

FIG. 28 is a screen shot showing another aspect of the another embodiment.

### DETAILED DESCRIPTION

A system and method for delivering advertising and non-advertising content includes a content management system for receiving content, editing received content (if necessary), storing content, and scheduling content for display in display systems.

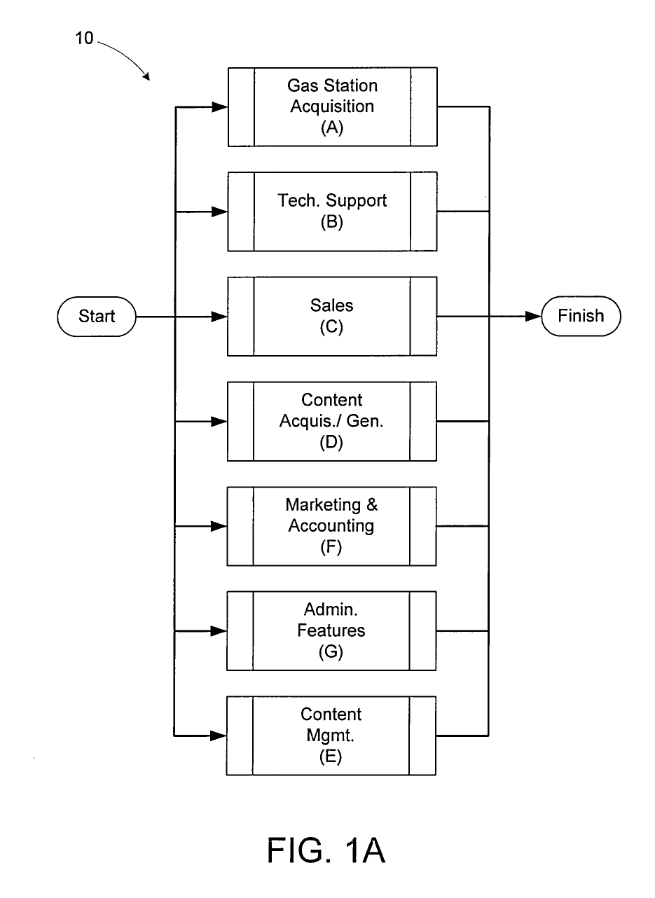

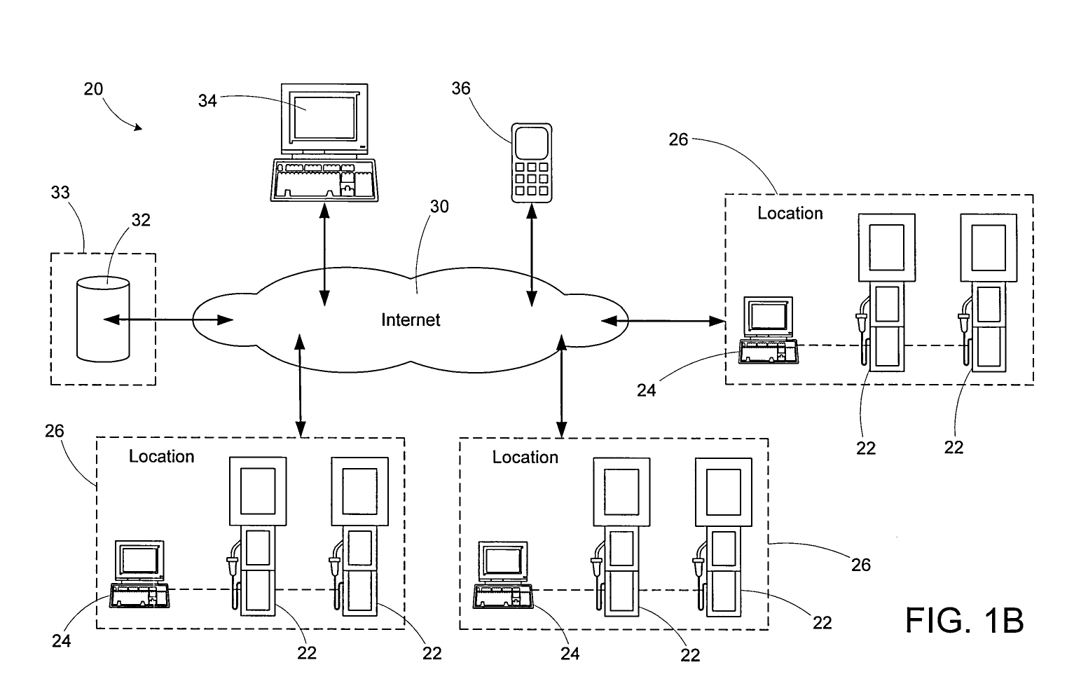

Turning to the drawings, FIG. 1A is a schematic diagram of the major functions of the Internal Management System (IMS) 10 for an Out of Home advertising network (herein called OOH network). The Internal Management System 10 is a system for delivering audio-visual content, including advertising and non-advertising content, across a network of screens.

The Internal Management System 10 can be used in a location-based OOH network or in an OOH network in the retail or outdoor segments. In the preferred, location-based type of OOH network, the network incorporates display screens in environments such as transit stations, restaurants and bars, office buildings, doctor's offices, etc. These locations often present high consumer dwell times. However, the OOH network of the preferred embodiment operates in a more limited dwell time environment, and the invention includes techniques for engaging and interacting with consumers during this limited dwell time, for example on the order of five minutes. In the illustrated embodiment, a network of gasoline stations displays content at “topper” digital displays placed on top of gasoline pumps. Although the explanation below is given in terms of a system in which the display screens are placed at gas stations, it will be appreciated that a similar system may have its display screens located at any of a wide variety of types of locations. Devices with display screens for displaying content may be referred to herein as “players,” with the display of content referred to as “playing.”

The IMS 10 includes a scheduling system, a system for distributing content across the OOH network, a network of display screens, and players for playing content at each of the display screens. An example of a system for distributing content across a network of display screens is shown FIG. 1 of U.S. Pat. No. 7,450,954, the detailed description and figures of which are incorporated herein by reference. A schematic diagram of an OOH network 20 is shown in FIG. 1B. The network 20 includes display devices 22 and local servers 24 at various locations 26. The display devices 22 and the local servers 24 are coupled to the Internet 30 (or another suitable network), to receive content. The content may be from any of a variety of locations, such as being stored in a storage device 32, such as on a server 33. The server 33 may be part of the IMS 10. Content may also be sent to the locations 26 and/or the server 33 from computers 34 connected to the Internet 30, and handheld and/or wireless devices 36.

Referring again to FIG. 1A, the Gas Station Acquisition module A enables the IMS 10 to add new locations to the OOH network. In the illustrated embodiment the OOH network comprises a nationwide network of gasoline stations. Module A permits the entry of customer information, which can help advertisers identify their target market. The network is made up of a series of locations. Within each location there can be one or several screens. Typically in a gas station environment there is a screen for every pump at the station, and potentially additional screens such as one or more screens within a convenience store attached to the gas station.

In entering a new gas station using module A the operator would generally enter information about the host company for the station, the branding of the station, and the presence or absence of a convenience store. Furthermore the user would enter the configuration of screens at the new station, and information about the network hardware. By tracking attributes such as attached convenience store and associated brand, the OOH network provides useful data for advertisers (e.g. for co-branding of products with convenience store brands, which are an increasingly important brand category).

As discussed below in the disclosure section on Viewer Interactive Gas Station-based OOH Network, besides a network of display screens at the top of gas pumps, the OOH network additionally can include one or more screens within any attached convenience store. When the OOH network manages a network of convenience store screens in addition to the gas pump topper screens, module A permits posting of location data about the convenience stores. Examples of such data include the host company of the convenience store, branding of the store, configuration of screen(s), and network hardware at the store.

Locations can be characterized by geography such as zip code, city and county, and Designated Market Area (DMA), signifying a media market. In addition given locations can be identified by their geo coordinates (GPS location). Given stations can be grouped within given localities such as DMAs, and by proximity (such as all network locations within X miles of a given station). This is an important aspect of the OOH network in facilitating the localized display of content for targeted advertising, community media, and other purposes.

Technical Support module B enables service technicians to identify and respond to hardware and software service problems in the OOH network. Preferably, the display units periodically communicate back to a central server of the OOH network, providing data on any system malfunctions. Field technicians can find and view network information for a given station, if they have permission for that station. Module B permits the technician to view, diagnose, and repair problems with one or a series of display units. In appropriate cases a technical may be dispatched to a station, for example in order to replace malfunctioning hardware.

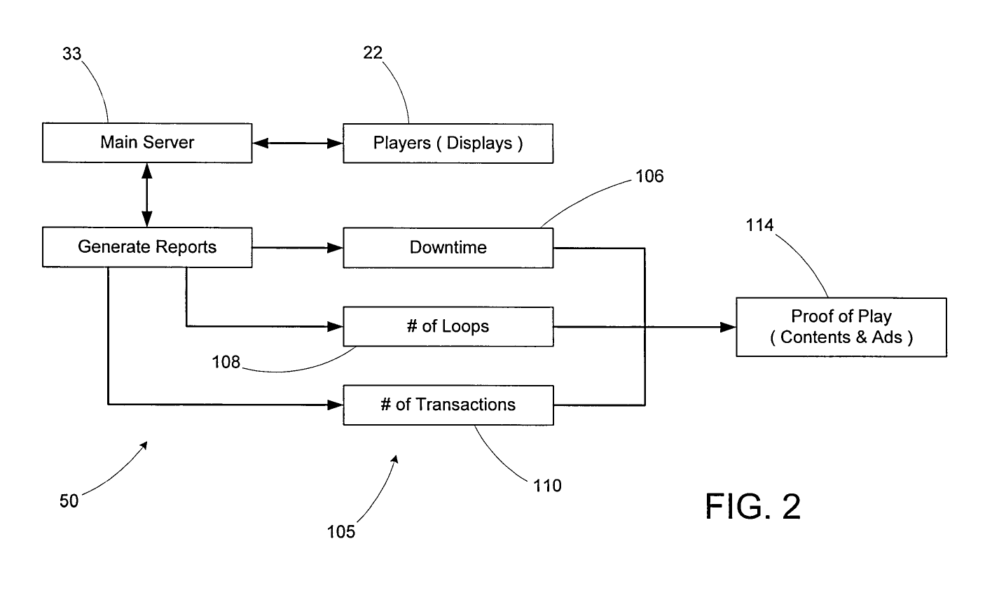

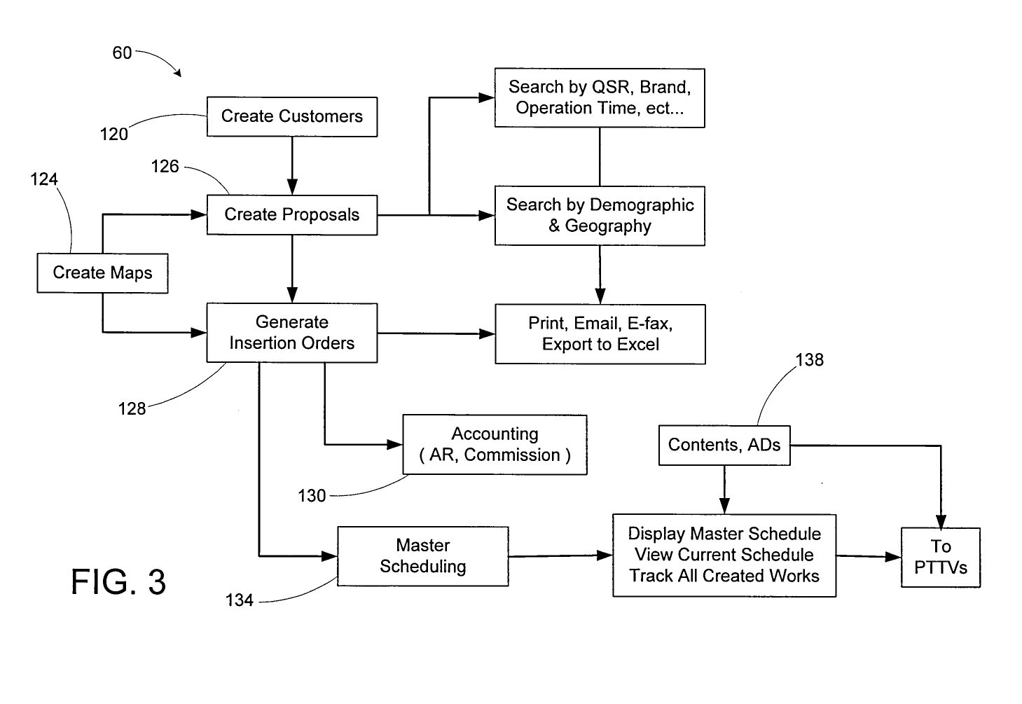

Sales module C tracks OOH network customers, and provides tools to permit sales managers to generate sales proposals. The sales module C also enables sales managers to generate insertion orders, i.e. customer orders to run advertising and non-advertising content on the OOH network. Further, the sales module creates various sales reports for customers. FIG. 2 shows a Master Report module 50 within the Sales Module C of FIG. 1. FIG. 3 illustrates an advanced Sales Support module 60 within the Sales module C of FIG. 1. The capabilities of Sales Module C are described below under the disclosure sections OOH Network Inventory and Sales Function.

Content Acquisition and Generation module D provides automated and manual tools for acquiring content items from third party sources as well as original content of the OOH network, and for generating content files that can be played on OOH network players. Content Acquisition and Generation is discussed below in the disclosure section Content Acquisition and Generation; OOH Network Automation.

Content Management module E includes a database or Content Library of content items and related information, and a subsystem for assembling content items into playlists or program wheels to play on network players. Content Management is discussed below in the disclosure section of the same title.

Marketing and Accounting module F receives information on insertion orders from the sales module and calculates Accounts Receivables resulting from insertion orders, and Commissions for sales representatives. This module also can track other costs and revenues not shown in FIG. 3, such as license fees for playing Licensed content (explained below under Content Management).

OOH network personnel use administrative module G to create and maintain database entries for various information categories such as DMAs (defining geographic scope); pricing structures; network products; sales representatives; network locations; etc.

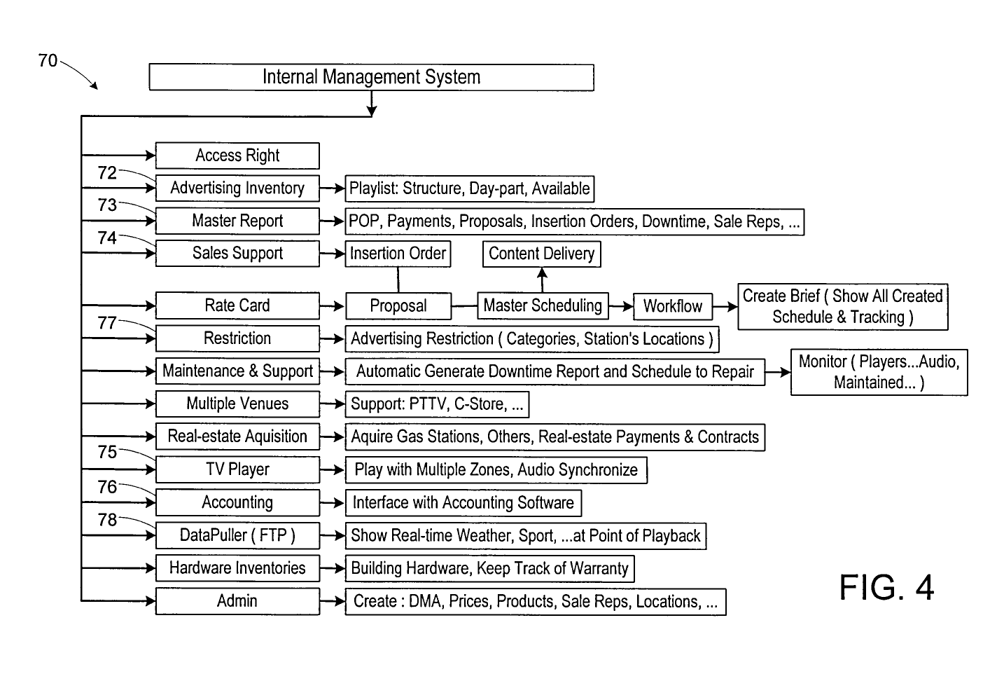

FIG. 4 shows functions 70 of the Internal Management System 10 in greater detail. These functions are explained below in disclosure sections titled OOH Network Inventory, Sales Function, Synchronized Digital Toppers with Zoned Displays, Content Acquisition and Generation; OOH Network Automation, and Content Management. The functions 70 include an advertising/inventory function 72, a master report generation function 73, a sales support function 74, a player function 75, an accounting function 76, a restriction function 77, and a datapuller function 78.

### OOH Network Inventory

The OOH network 20 (FIG. 1B) provides advertising services and non-advertising content distribution services across the locations (e.g. gas stations, with associated topper displays) included in the network. This type of display technology is sometimes called digital signage, and includes computer-controlled electronic display devices (sometimes called “players” in the present disclosure). The OOH network 20 manages and controls the display of advertising and non-advertising content.

In the present disclosure, except where otherwise apparent (such as in the phrase “non-advertising content”) the term “content” encompasses any type of audio-visual content including but not limited to advertising that may be displayed on players of the OOH network. The storage and management of content by a Content Management module of the OOH network is described in detail below at “Content Management.” The following is an explanation of the OOH network's Inventory function—the Advertising Inventory function 72 of FIG. 4. This function is called the OOH Network Inventory function in the discussion below with regard to FIG. 5.

As shown in FIG. 5, a Content Management module 80 tracks individual content items in a database called the Content Library 82, and provides tools to assemble content items into “program loops” or “program wheels” 84. The content management module 80 (and other items shown in FIG. 5) may be parts of the OOH network 20, also shown in FIG. 1B and discussed above. The display screens of OOH network players 22 may be subdivided into a plurality of zones, with different content items played simultaneously in different zones. A program wheel 84 comprises a set of content items that are programmed to play in given display zones and time segments within a set time interval (the duration of the program loop). The program wheel 84 may be played repeatedly or looped during a scheduled time period, after which a new program loop may be played. Zoned displays and program wheels 84 are explained below in greater detail.

The OOH network 20 tracks the scheduled playing of content by the OOH network in an OOH Network Inventory module 86 (FIG. 5). The Inventory module 86 communicates with the Content Management module 80, so that sales personnel 88 may use the Inventory Module 86 to search for content items in the Content Library 82. Both the Inventory module 86 and the Content Management module 80 communicate with the OOH Network's central server 33, which in turn communicates with players 22 of the OOH network 20. The central server 33 sends the players 22 playlists or program wheels assembled in the Content Management module 80, and these playlists are compatible with the inventory structure. A structure of inventory with multiple components is described immediately below.

This inventory consists of “inventory slots” or “play slots” for scheduled play of advertising and non-advertising content items. There are two primary components of an inventory slot:
(a) a scheduled time period; and
(b) a geographic location (e.g. a particular gas station, assuming that all players at that station play the same content, at least by default).

As used in the present patent application, a “scheduled time period” refers to a time period on a given day during which a particular collection of content items is scheduled to be played. In the preferred embodiment, the collection of content items comprises a particular playlist or program wheel that is played repeatedly during the scheduled time period. The scheduled time period may consist of a DayPart (such as 7-11 am, 11 am-3 pm, 3 pm-7 pm, and 7 pm-11 pm). A scheduled time period is a unit period of time for defining inventory slots (such as a DayPart); in practice, given content items often are played over a consecutive scheduled time periods such as all scheduled time periods during a day, or during a number of days.

The slots in inventory can be analogized to seats on an airplane. When the scheduled time period associated with a given inventory slot has expired, the player associated with that inventory slot communicates to the main server of the IMS that the slot has become available again.

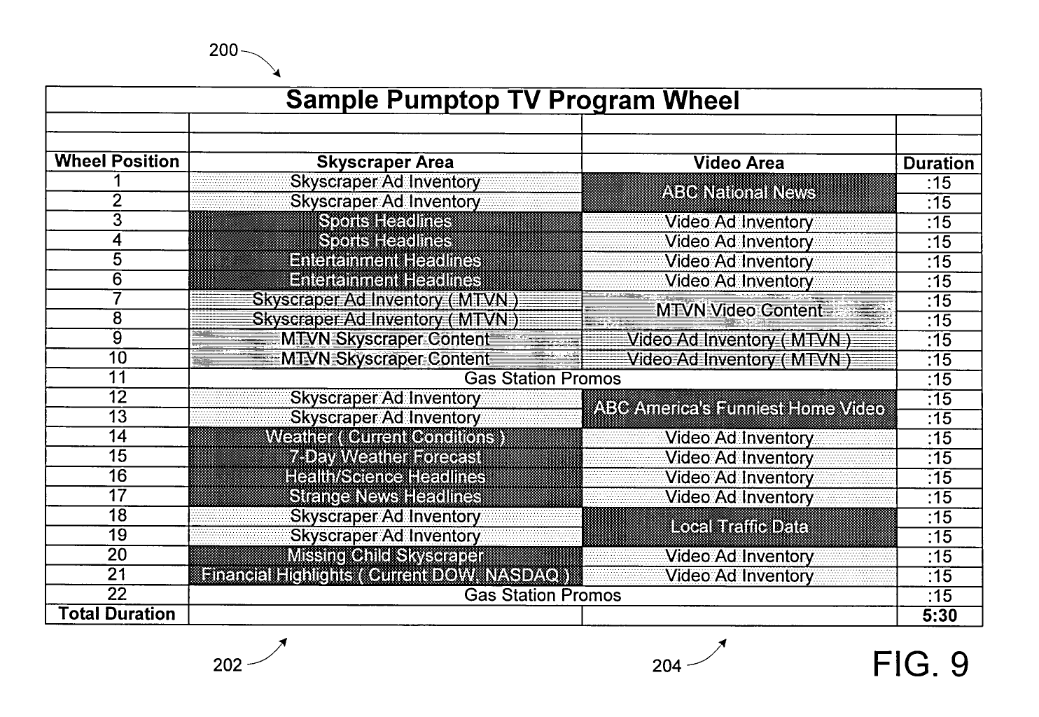

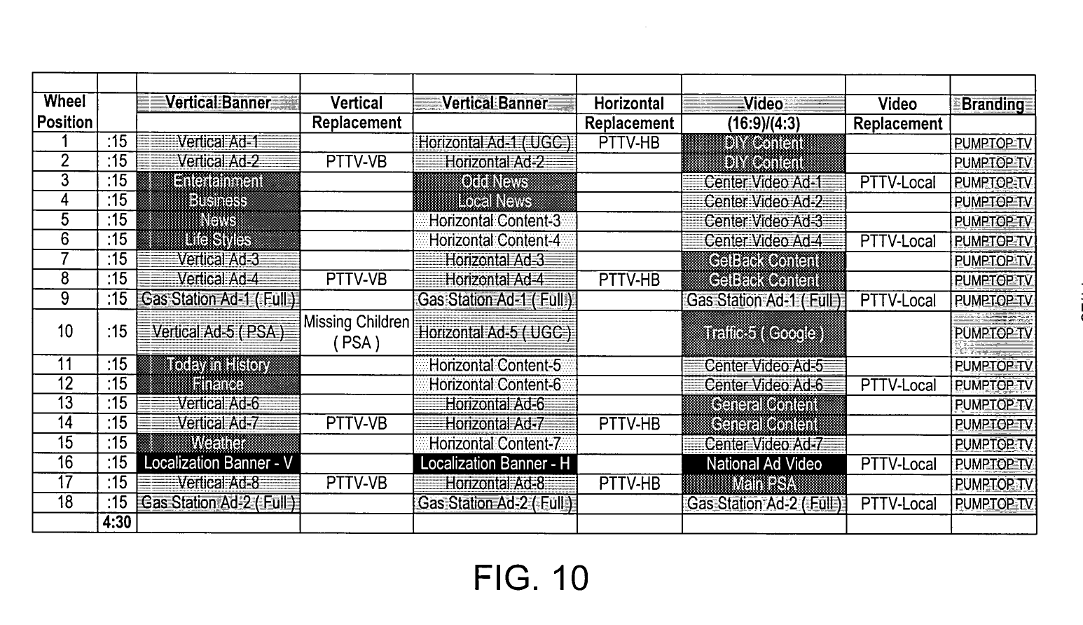

In addition, in the preferred embodiment in which content items are organized in program wheels, an inventory slot may include the following additional components:
(c) a time segment within the duration of the program wheel; and
(d) a display zone (in a multi-zone display)
   Examples of time segments and display zones within a program wheel are given below in the discussion of the program wheels of FIGS. 9 and 10.

Thus for the OOH network to uniquely identify an inventory slot within program-wheel based, multi-zone programming, all four components are required. However in selling inventory, commonly only the first two components are selected by an OOH network client ordering insertion of a content item, and the other components are determined as part of network management.

There is an important difference between scheduled time periods and the time segments within a program loop or program wheel. The duration of a program wheel typically corresponds to the dwell time of an end user (viewer) at the display location. For a gas station-based OOH network around five minutes is exemplary program wheel duration. The time segments for playing given content items within a program wheel typically are short intervals such as thirty or fifteen seconds. On the other hand, the scheduled time periods are much longer time intervals during which a given program wheel assigned to that time period may be played repeatedly or looped.

As discussed immediately below in the disclosure section Sales Function, the traditional approach to sales involves personal interaction between an OOH network sales professional or other client. However, the OOH network also permits automated sales of inventory. Typically, automated sales involve a group of inventory slots that are set aside or “reserved” for a particular sales program. Reserved inventory slots may be dedicated to a particular Content Management Type, such as user generated content (UGC) or local advertising. Inventory also may be reserved for other purposes such as a particular Content Genre. Content Management Types and Content Genres are explained in the disclosure section on Content Management.

An OOH network manager may increase or decrease the volume of inventory slots reserved for a particular automated sales program, on a long term basis (e.g. in response to decreasing popularity of a given sales program) or short term basis (e.g. when orders have been placed for all inventory slots reserved for a given sales program). Reserved inventory can be increased or decreased by shifting inventory slots into or out of a block of reserved inventory from other inventory of the OOH network, such as other blocks of reserved inventory. Reserved inventory also can be increased or decreased by increasing or decreasing the duration of program wheels.

Another consideration in managing inventory is the range of inventory slots ordered by a given client, e.g.:
an entire program wheel;
a portion of the program wheel, limited by time segments and/or display zones;
a series of scheduled time periods encompassing consecutive days (such as a week);
programming during given DayParts but not for the entire day;
given geographic locations—e.g. given DMAs, zip codes, stations.

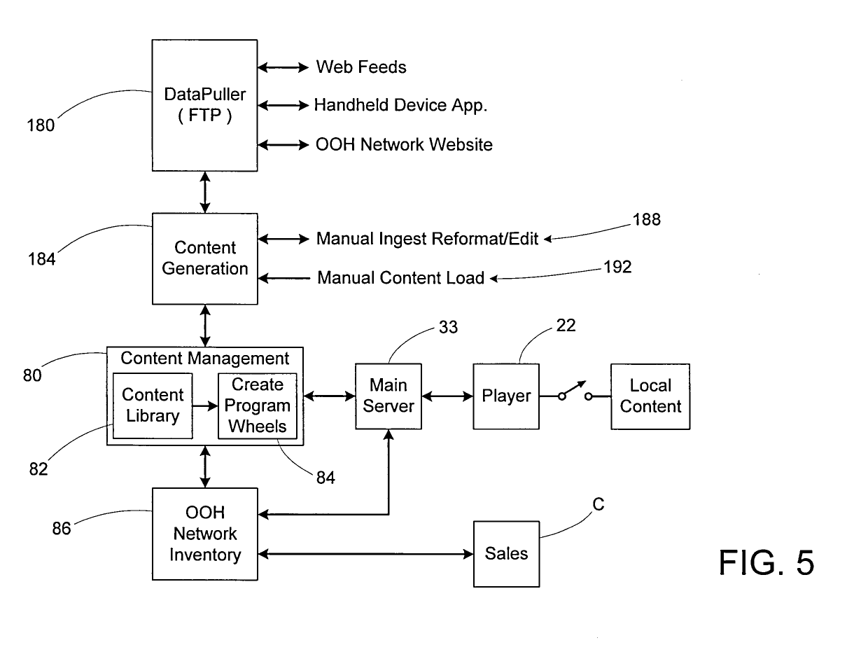

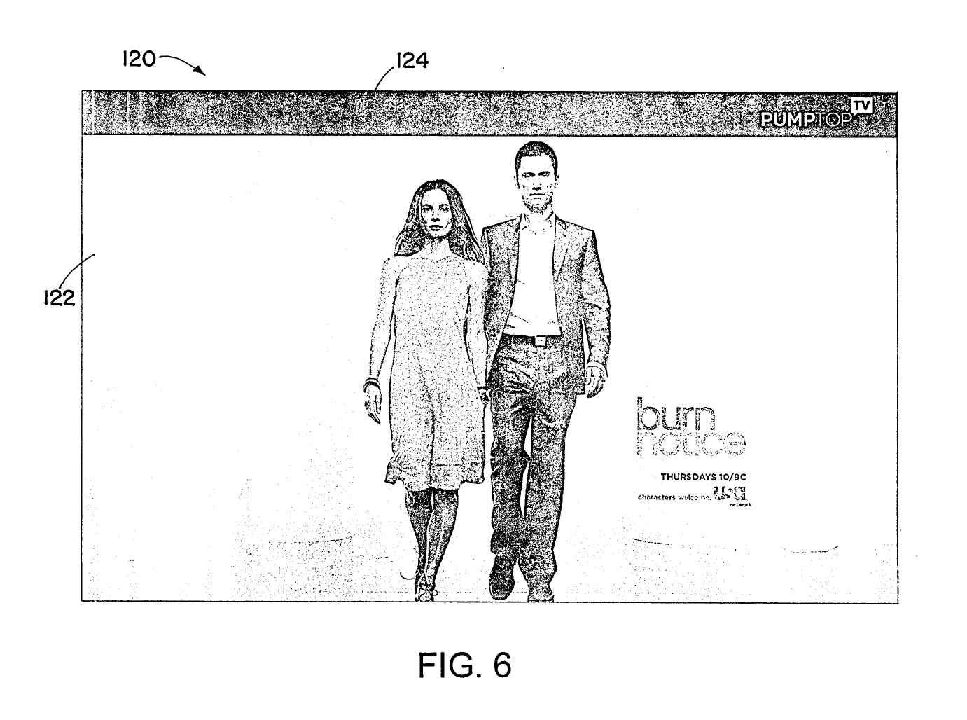

Although the present disclosure focuses on management by the Internal Management System 10 (FIG. 1) of a single OOH network 20 (FIG. 2) of gas stations using digital signage branded PUMPTOP TV (such as shown FIGS. 6-8), it will be appreciated that the Internal Management System 10 can manage multiple display networks as discussed below in the disclosure section titled Viewer Interactive Gas Station-based OOH Network. (See FIG. 4 and the discussion below regarding multiple venues.) Furthermore, a client can even sponsor an entire OOH network, in which case the Internal Management System 10 would manage all programming for that network as the client's inventory, and branding for that programming would be replace the network brand PUMPTOP TV (as seen for example in the display layout of FIG. 6) with the client's brand.

### Sales Function

The sales module C draws upon information on inventory of the OOH network as discussed above at OOH Network Inventory, in searching for available inventory, holding inventory, and processing orders for inserting content items into inventory, as described below. Sales module C supports sales activities by OOH network personnel, as well as automated sales programs.

As used in the present patent application, to “reserve” inventory means to set aside inventory slots so that they only can be used for a particular OOH network purpose, such as an automated sales program. “Available” inventory means inventory slots—often comprising reserved inventory—that have not been ordered. To “hold” inventory means to remove inventory slots from available inventory for a limited period of time, in view of a potential order. To “sell” inventory means to permanently remove an inventory slot from available inventory, typically because an advertiser or other client has “ordered” (also called placing an “insertion order”) insertion of a content item into the inventory slot. Sale of inventory slots may or may not involve purchase of the inventory slots.

The sales module C (FIG. 1A) tracks customers, and permits marketing and sales personnel to enter new customers into the IMS 10. Sales Module C provides templates to generate proposals to prospective customers. A sales manager can consider the needs of a given customer and search the Content Library 82 (FIG. 5—also discussed further below) of the IMS 10 for given advertising and other content items to include in the proposal. Given advertising/content items are displayed and the system calculates associated pricing. If the user selects a given item for inclusion in the proposal it is added to the basket for that proposal. The manager continues searching for content items until the basket contains all desired content items with pricing, whereupon module C saves the basket as a proposal.

The sales module C provides the ability to hold inventory that is subject to an advertising proposal for a period of time. During this period, which may be for a number of days (for example), the held inventory is not available to be ordered by other clients. A variation of held inventory is used in automated sales programs such as the User Generated Content (UCG) application discussed below. UGC inventory slots identified by a user for potential ordering are held for a short period (e.g. ten minutes) while the user decides which slots, if any, to order.

Advertising rate tables can be used in calculation of pricing given the set of network locations included in a proposal, based upon historical viewer “impressions” realized at those locations. If more sophisticated methods of measuring viewership are used, these measurements also can be factored into rate tables. Gas station (network location) impressions, and other ways to measure viewership, are discussed below.

The sales module C also generates insertion orders, i.e. orders to insert advertising and other content items into content playlists or program wheels of the OOH network 20, as described below. The process for formulating insertion orders can be like that for creating proposals, including searching the Content Library 82 for content items based upon the characteristics of a given customer, and collecting content items with associated pricing in a basket. A sales manager also can use a previously created proposal to generate an insertion order, either in its original form or after editing the proposal.

The sales module C also enables users to generate sales reports, such as proof of play reports. Proof of play reports can combine information about the content that was scheduled to be played during a given period (e.g. activities during a given month or calendar quarter), with information about the display of advertising and other content to viewers that location (advertising impressions). It is important to advertisers to measure the audience or viewership of their advertising displays, and the present OOH network 20 provides various levels of audience measurement.

A first type of audience measurement is advertising reach, measuring the number of people who are exposed to the advertisement. The OOH network 20 may use viewer “impressions” for this purpose. In the case of a gas station OOH network, a simple model to use in generating a proof of play report is to assume a single viewer during a gas-up transaction at a given gas pump, and count this transaction as a single advertising impression. This model reduces the count of impressions based upon any downtime of the gas station toppers.

FIG. 2 shows a master report module 50 within the sales Module C of FIG. 1A. A report generator 104 draws upon data in the main server 33, which can include data 105 received from network players 22. The latter data can include player downtime 106, number of loops played 108, and number of gas-up transactions 110, data used in calculating viewer impressions as discussed above. The data 105 can be used to generate proof-of-play reports 114. In addition (not shown in this view) the data 105 received from the players 22 can include more advanced viewer measurements, as discussed below.

The OOH network 20 can provide more comprehensive measurement of viewer impressions using audience-sensing technology such as video cameras. For example a video camera located in or adjacent the pump top display device (or other player) 22 can detect the presence of one or multiple viewers, thereby counting e.g. two impressions instead of the assumed single viewer where appropriate. Furthermore, video cameras using facial recognition software can sense whether and when a given viewer is looking at the gas pump display, and this information can be factored into the impressions data.

A second type of audience measurement is viewer characteristics that can be used in targeted advertising, including viewer demographics and psychographics (e.g. activities and interests). The OOH network 20 can include technology to measure such viewer demographics and psychographics, thereby providing additional viewer measurement data of interest to advertisers. One viewer-sensing approach uses a video camera at the display together with facial recognition software to measure viewer demographics (e.g. gender, age, and ethnicity). US Patent Application 20040240708 discloses a facial recognition method that assesses a user's face and head pose such that a computer or like device can track the user's attention towards a display device. Commercially deployed digital signage systems such as those of TruMedia Technologies (Yehud Israel) can detect and track the faces of nearby viewers in public venues in order to measure visual exposure to advertising media.

In traditional design of digital signage displays such as gas pump toppers, viewers have no way to provide input to an OOH network. Improved OOH network facilities can provide viewers a mechanism to comment on displayed content, and a way for viewers to provide personal information and information on activities and interests, and the like. Technical platforms for viewer feedback include key pads or touch screens; OOH network applications for hand-held devices such as mobile phones; and access to public data about viewers who pay for gasoline or other goods or services using a credit card. User interaction with the OOH network using a handheld device is disclosed below in the disclosure sections User Generated Content, and Viewer Interactive Gas Station-based OOH Network

The sales module C can integrate impressions data, as well as other viewer reach, demographic, and psychographic data, into proof of play reports. At a basic level this would be done using viewer impressions data (and viewer sensing and feedback data, if applicable) collected at given display locations. This data can be correlated with information on the advertising that was scheduled to be played at that location during a period of time when the impressions data was collected—e.g. a count of impressions at a given location during a month in which the advertiser ran a particular advertising campaign at that location.

Advanced viewer-measurement data for proof of play reports include viewer interactions with the OOH network indicating viewers' interest in advertising or actions in response to advertising. Examples of handheld device-based responses to advertising includes downloading a coupon, and conducting ecommerce. An example of targeted advertising is an identified mobile phone user at a network location who is registered with the OOH network. Using these advanced audience measurement techniques, digital signage proof of play reports can supplement or replace traditional CPM (cost per thousand impressions) data with CPM-based targeted advertising data, and with measurements of viewer responses to OOH advertising that can be analogized to cost-per-click, or CPC, web advertising.

FIG. 3 illustrates an advanced sales support module 60 within the sales module C of FIG. 1A. A first step is posting of data for new customers, such as at 120. This sales support module 60 enables sales staff to create custom maps 124 of network locations fitting customer requirements. The maps data 124 and customer data 120 are used in creating proposals 126 and in generating insertion orders 128. The accounting module 130 (module F in FIG. 1A) handles accounts receivable and commissions resulting from insertion orders. The order insertion module 130 also updates master scheduling at 134 (the OOH network inventory function 86 in FIG. 5). Sales personnel can display the master schedule 134 of the OOH Network 20, can view a current schedule e.g. for the current week or month, and can track all content items in the OOH network 20. These displays and reports draw upon both master scheduling (network inventory) and the content library, shown in FIG. 3 as “Contents, Ads” 138.

Synchronized Digital Toppers with Zoned Displays

Commonly-owned US Patent Application 20080065475, which is incorporated herein by reference in its entirety, discloses a visual and audio display system for advertising and other content such as entertainment and news at locales such as gasoline stations. The system employs a large screen outdoor audio/visual display (gas pump digital “topper”) in the environment of a gasoline station and adjoining convenience store, if present. A plurality of spaced apart audio/visual display units at the station each is driven by an audio/video amplifier receiver. With reference to FIG. 1B of the present application, the display devices 22 are used to display content at various locations 26.

An audio/video distribution box with a CPU is interconnected with each of the plurality of audio/video display units for delivery of synchronized signals. This apparatus provides synchronized audio/video to a customer within a listening and viewing area defined by the plurality of audio/visual display units, in order to reduce extraneous noise affecting the customer.

In one embodiment, the apparatus incorporates a wireless local area network (WLAN) that distributes the synchronized audio/video signals to the audio/visual display units via a wireless distribution method. The wireless network may be based upon the IEEE 802.11 (WiFi™) set of standards, or other standards such as Bluetooth, 802.15.4 (ZigBee) or radio frequency identification (RFID). The display units incorporate audio/visual amplifier receivers to receive the synchronized audio/video signals. If it is preferred that the audio/video signals be accessible only by the display units, these signals would be secured against unauthorized access. Alternatively as discussed below at the disclosure section Viewer Interactive Gas Station-based OOH Network, the audio/video signals can be open to mobile phone users at the gas pumps who wish to join the WLAN network.

The apparatus may incorporate a wide area network access point for wireless access to the internet. Preferred wide area networks are based upon mobile broadband technology, using mobile phone lines for wireless high-speed internet access. The mobile broadband may be based upon the International Mobile Telecommunications-2000 family of standards for mobile telecommunications defined by the International Telecommunication Union, better known as 3G. 3G-compliant mobile phone technologies include for example GSM EDGE, UMTS, and CDMA2000 as well as DECT and WiMAX.

The gasoline station pump toppers located at participating gasoline stations display content transmitted from a central server of the OOH network, such as the server 33 of the network 20 (FIG. 1B). As illustrated below, the content may comprise a variety of static graphics, text, audio and full-motion video content in a continuous loop with the content being stored in the computer. The content is delivered throughout each day via a secure internet connection. Mounted on top of each gas pump, a preferred topper design is comprised of two back-to-back display screens housed inside a vandal-proof enclosure. The installation allows for viewing from both sides of the gas pump.

In an alternative embodiment, the WLAN is capable of distributing individual content to each of the gasoline station pump toppers at a participating gasoline station. Individualized content also includes standard content playing at a station with one or more screen playing individual content. Individualized content is useful for example to provide content targeted to a viewer at a given screen. Each of the audio/visual display units includes its own CPU to control that display unit. The audio output may no longer be synchronized among the different display screens at the station. To avoid discord between nearly audio outputs the display units may include directional audio speakers that focus output sound within a relatively narrow zone in front of each gas pump.

As seen in the schematic diagram of FIG. 5, each player 22 of the OOH network 20 normally plays program wheels received from the main server 33 of the network 20. In this embodiment the player 22 may be switched to a local content source at the gas station. While in the local content configuration, the player 22 will play the local content but will continue to send periodic status information to the main server 33. Local content storage facilitates the embodiment in which each display screen can play individualized content. The station can efficiently switch a given player from standardized programming to locally stored programming, e.g. selecting a program wheel that is targeted to a viewer at that screen.

FIGS. 6-8 show various possible layouts of the display screen of the player 22. The layout 120 of FIG. 6 includes a single display zone 122, the video area that occupies most of the screen. The horizontal area 124 at the top of the screen can be used to identify and brand the OOH network 20 (FIG. 1B), but is not used as a display area.

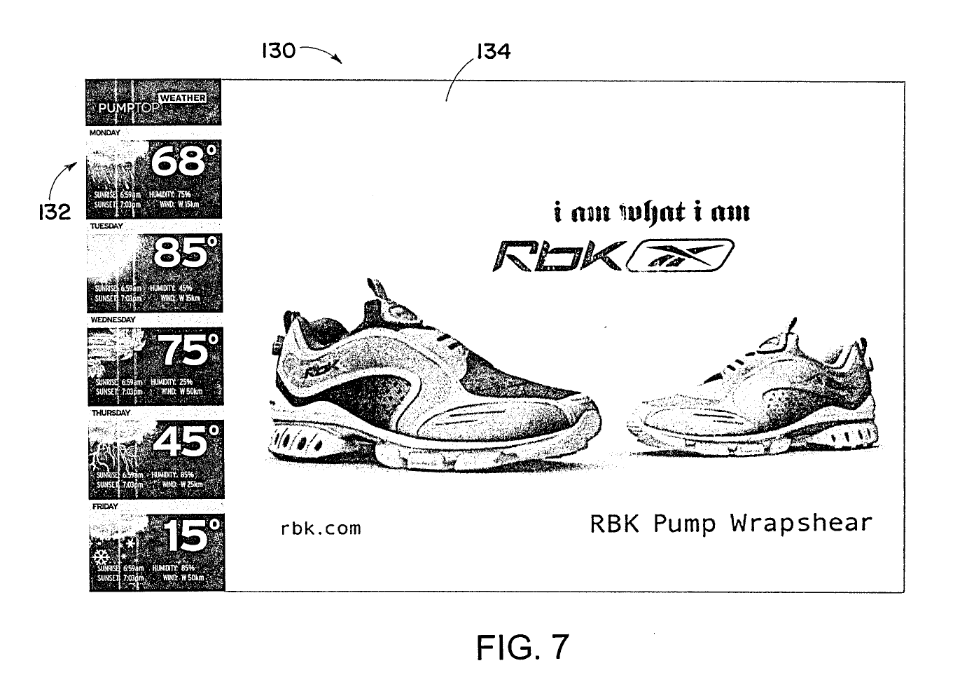

FIG. 7 shows a layout 130 divided into two display areas 132 and 134, called “zones” in this patent disclosure. The left side of the screen is a vertical banner or “skyscraper” 132 that may display static or moving content. The right half of the screen is the video area 134, and preferably occupies most the screen. In one embodiment, the topper delivers audio for the video area 134, but not for the skyscraper 132.

In an illustrative embodiment using the layout 130 of FIG. 7, the skyscraper 132 occupies approximately 25% of the entire screen and measures approximately 4 inches wide by 9 inches high. The skyscraper area does not deliver any audio, but can include movement. The video area 134 at the right side occupies approximately 75% of the screen and measures 12 inches wide by 9 inches high. The video area may be in a 4:3 aspect ratio, just as in a regular television format, and may deliver audio.

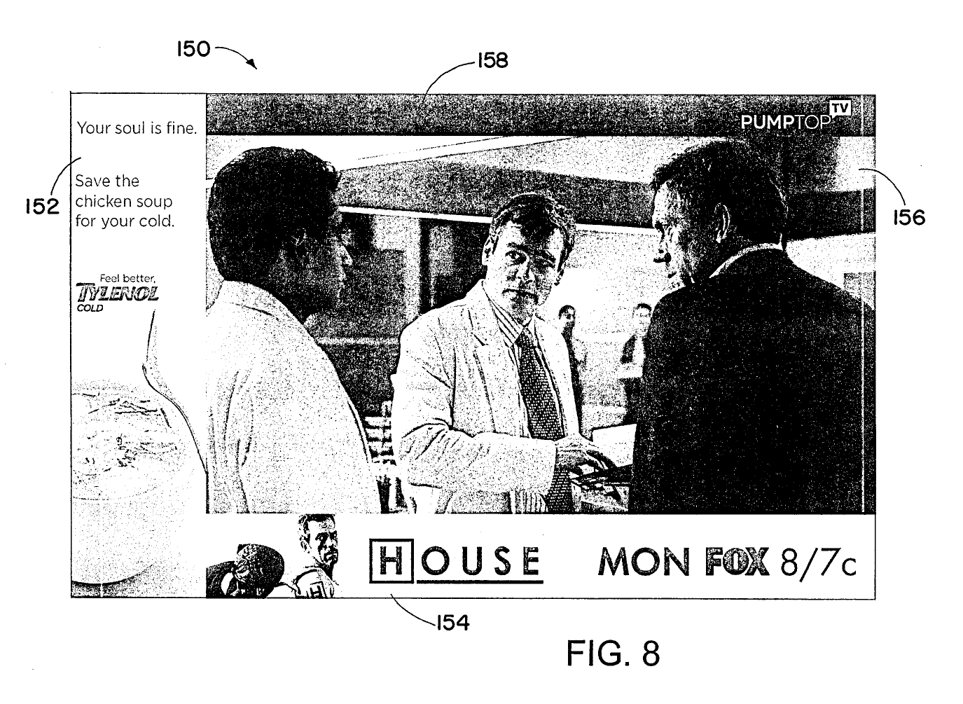

FIG. 8 shows a layout 150 divided into three zones 152, 154, and 156. These include a vertical banner 152 at the left side of the screen, a horizontal banner 154 at the bottom of the screen, and a video area 156. Among other effects that can be achieved with this layout, the horizontal and vertical banners 152 and 154 can be combined in displaying content to create a “wrap around” banner. A horizontal band 158 above the video area can be used.

A variety of display layouts (zones) can be used besides the examples shown in FIGS. 6-8. Besides division of the primary plane of the display into different area zones, the zone concept extends to a multi-layered display layout. Multi-layered zone layouts can use known techniques for graphic overlays such as transparency, texturing and tinting.

Providers of content or advertising to be run on players 22 of the OOH network 20 can follow production guidelines dictated by the technical requirements of the players 22, and the design of program wheels (see Content Management, below). Alternatively as discussed below, the Content Acquisition and Generation function of the OOH network can transcode or edit content items to ensure compatibility with player hardware and software specifications.

For full motion video content items, illustrative production guidelines include: video format: e.g. WMV, AVI, MPEG1, and MPEG4; frame size (vertical and horizontal pixel counts); video bit rate; audio: 2 channels (stereo) with specified sample rate; audio level; and text size (for gas pump displays it is recommended that text be viewable from up to five feet away).

For still pictures and animation content items displayed in the video zone, illustrative production guidelines include: file format: MPEG, GIF, GIF animation, and BMP; image size (vertical and horizontal pixel counts); audio file format: MP3, WAV; audio: 2 channels (stereo) with specified sample rate; audio level; and text size (for gas pump displays it is recommended that text be viewable from up to five feet away).

Pictures intended for skyscraper or banner display can follow the illustrative production guidelines: image size (vertical and horizontal pixel counts); file format: JPEG, GIF, GIF Animation, and BMP; and text size (for gas pump displays it is recommended that text be viewable from up to five feet away).

Particular production guidelines may be provided for content items using the “SWF” Adobe Flash file format, a format developed by Adobe Systems Incorporated, traditionally called ShockWave Flash movies. Illustrative production guidelines for Flash video include: format: SWF; frame size (vertical and horizontal pixel counts); video bit rate; audio: 2 channels (stereo) with specified sample rate; audio file format: MP3, WAV. SWF files also can be used in animated skyscraper or banner content, in which case a smaller frame size is used, without audio.

### Content Acquisition and Generation; OOH Network Automation

Out of home networks can broadcast content created by the network itself, or can broadcast content created by third parties. In traditional operation, content files have been sent to the OOH network by email or, for large files, using removable media. These content files have been loaded manually onto the OOH network, and related network operations have all been manual. These network operations include filtering (selective ingest of content items based upon OOH network standards); transcoding, reformatting or editing content items (as needed to meet network specifications); maintenance of the OOH network's content library or database; integration of content items into playlists or program wheels; and network inventory and sales functions such as confirming inventory availability and placing insertion orders.

According to one embodiment, the present invention uses a file transfer method in which high quality media files are exchanged over Internet Protocol (IP) networks. A datapuller module automatically acquires content files from third party content sources. The method for acquiring and managing content items also can automate or facilitate various functions including network inventory and sales functions; filtering content items; transcoding and editing of content items; and assembling program wheels. These functions still can be and in many cases will be carried out manually, but the present patent disclosure provides techniques for and examples of workflow automation of these functions.

Referring again to FIG. 5, a datapuller module 180 uses the File Transfer Protocol (FTP) to exchange content files and content-related data (metadata herein called content tags) over a TCP/IP based network, typically the Internet. The FTP is based upon a client-server architecture, in which the datapuller 180 is the FTP client and a source of content files (such as a content distributor that publishes web feeds) is the FTP server. In passive mode, the content server opens a dynamic port, sends the datapuller 180 the server's IP address to connect to and the port on which it is listening over the control stream and waits for a connection from the datapuller 180. In active mode, the datapuller 180 opens a dynamic port, sends the content server the dynamic port number on which it is listening over the control stream and waits for a connection from the content server.

FIG. 5 shows various types of content source: web feeds 182 such as RSS feeds, an OOH network website 184, and an application on a handheld device 186. It is known for OOH networks to acquire content (e.g. news, weather, sports, and health content) via web feeds. For example, third party services such as Datacall Technologies of Houston Tex. support digital signage clients with live data feeds. However, the datapuller 180 of the invention handles this function in-house, along with improved content generation and content management functions as discussed below. As indicated in FIG. 4, the datapuller 180 can provide a datapuller function 78 that may include obtaining real time weather, sports, and other web feeds content to viewers at OOH network players 22.

Novel OOH network content acquisition and management processes involving an automated sales application for a handheld device is discussed below at the disclosure section User Generated Content. OOH network content acquisition via a content posting website managed by the OOH network is discussed below at Content Posting via OOH Network Website. As discussed below, in each of these content acquisition and management processes the server device (handheld device, and host device for OOH network website) includes an automated sales program that guides content providers in ordering the insertion of content items in OOH network inventory, scheduling display of content items at one or more selected OOH network location.

Each application program interface (API) of the datapuller 180 controls a two way data exchange between the OOH network and the server devices that can be used for posting content items in the OOH network. APIs can automate OOH network functions normally carried out by network personnel. An API can carry out automated sales functions, such as searching for available inventory. An API can either insert an available content item into inventory automatically or can offer a content provider the choice to order inventory. Examples are disclosed below in the sections on User Generated Content and on Content Posting via OOH Network Website.

APIs at the datapuller 180 also can control ingest of content items into the OOH network 20. As used in this disclosure, ingest means selectively accepting content items for display by the OOH network 20, possibly in modifying content items from the original form. Typically ingest involves filtering content in view of standards of the OOH network 20. A content item that violates OOH network standards may be rejected by the datapuller 180, or may be edited to eliminate or modify objectionable elements. An example of filtering is disclosed below at User Generated Content (UGC), involving UGC items in the form of micro blog posts comprising text data. An API at the datapuller 180 includes profanity filter software that rejects a UGC item with words deemed offensive, or that edits the UGC content item to remove these words. Other types of filtering (e.g. filtering to avoid copyright violations) are known. In addition, the content ingest function of the OOH network 20 may rely on human review of content items instead of or in addition to filtering at the datapuller 180.

The datapuller 180 receives and stores content items that may be added to the permanent content database (content library) 82 of the OOH network 20. When the datapuller 180 receives a file including the content item itself, typically this file also includes metadata concerning the content item, or content “tags”. Examples of metadata include characteristics of content items, information about companies or individuals associated with content items, and instructions from content suppliers for playing content items on the OOH network 20. Content tagging is discussed below in the section on Content Management. APIs at the datapuller 180 can automate content management functions, such as tagging content items with OOH network categories, updating the content library 82, and inserting content items into program wheels. An example is given below at User Generated Content.

A content generation module 184 outputs content items in appropriate format to be displayed on the OOH network 20. It may be necessary to transcode, reformat or edit content items received from the datapuller 180 for network compatibility. Examples include (but are not limited to):
Transcoding video or audio file formats to satisfy player specifications;
Changing the duration of content items to match program wheel time segments;
Editing content items (e.g. to shorten their duration) while preserving meaning and retaining viewer impact; and
Editing content items to satisfy network standards (e.g. eliminating or masking objectionable words, or removing a copyright protected song from a user generated video).

The datapuller 180 can push content items and metadata to the content library 82, as is disclosed below at User Generated Content. Alternatively content items can be extracted from datapuller storage by a network operator—the manual ingest function 188 of the content generation module 184 shown in FIG. 5. In this case, the operator normally reviews content items stored in the datapuller 180, to decide whether to pass each content item to the content library 82, and whether to reformat or edit the content item.

Traditionally the reformatting or editing of content items for OOH networks or digital signage display has been a manual process, and this approach may be used in the present content generation method/module 184 as shown in FIG. 5 at the manual ingest reformat/edit 188. However it also is possible for the content generation module 184 to utilize computer-assisted techniques. Products and techniques for digital media ingest can automate or facilitate editing, formatting, compositing, and storage of media with video and audio file formats. Telestream Flipfactory™ of Telestream, Inc. Nevada City, Calif. is a product line that automates the transcoding of film-based media. The Flipfactory product line transcodes a ranges of video and audio file formats and wrappers. Techniques for automated ingest of digital media, including video and audio file formats, are disclosed in US Patent Application 20050267894 (XML metabase for the organization and manipulation of digital media) and US Patent Application 20070113184 A1 (system for ingesting a feed to create a media file, and editing the media file using a reduced size proxy file of the media file).

It also is known in such systems to extract or generate metadata from a digital media ingest; for example this is a primary technique disclosed in US Patent Application 20050267894. Thus in addition to automated transcoding or editing of content files received by the datapuller 180 to generate content files compliant with OOH network player formats, the content generation module 184 may extract metadata from received media files to generate content tags consistent with content tag formats used by the content management module 80 (content library 82).

As disclosed below in the discussion of program wheels, the content generation and management techniques of the invention permit the presentation of a flexible range of programming formats, e.g. delivering “content bites” of 30 seconds duration and shorter. This includes dividing “normal” time segments into two time segments, or more than two time segments. For example, a 30-second time segment can be divided into two 15-second time segments, and a 15-second time segment can be divided into three 5-second time segments. This flexibility also extends to display layouts, which can include other arrangements besides those shown in FIGS. 6-8.

In order to accommodate this flexibility in display formats and program wheel formats, the content generation module 184 can provide different versions of the same basic content item. Examples include content versions having different durations, different frame sizes, or different audio-video formats. Another application of content versions is localized content items, which have different versions for different network locations, as discussed in Content Management below.

As explained above in this section, the OOH network's internal management system 10 (including APIs at the datapuller 180) can automate or partially automate various OOH network functions for content items posted to the OOH network by content providers. Table 1 shows examples of automation of various OOH network functions. The OOH network 20 can automate one or more network function for a given type of content provider device based upon factors such as the use of reserved program wheel slots to simplify inventory management and programming; the type and diversity of content items; the number and value of content posting transactions; and the use of formatting tools to ensure compliance with OOH network requirements. For example, applying these factors to the exemplary handheld device application at User Generated Content, all network functions are automated or bypassed. As another example, an OOH network web site can provide local advertisers with a template for creation of advertising content items wherein the template ensures compatibility with network formatting requirements.

TABLE 1
OOH NETWORK AUTOMATION EXAMPLES

| Network | Not | |
|---|---|---|
| Function | Automated | Automated |
| Sales/Inventory | Sales representative | Automated offer and ordering |
| Management | prepares proposal and | of available inventory |
| | insertion order | |
| Content Ingest | Human screening of full | Automated profanity filtering |
| | motion videos | of micro blog posts |
| Editing/ | Human text editing to | Automated transcoding |
| Reformatting | preserve messaging | |
| Content | Human programmer | Automated insertion of |
| Management | assembles program | content items into program |
| | wheels | wheels |

As an alternative to introducing new content items through the datapuller 180, an OOH network operator can introduce content items into the OOH network manually at the content generation module 184, as indicated at 192.

Once content items are processed by the content generation module 184 to be fully compatible with requirements of the OOH network, the content items are forwarded to the content management module 80.

### Content Management

The content management module 80 includes two major sub-systems, a content library 82, and a system 84 for creating program wheels. The content library 82 is an indexed database of content items that can be searched for content items to create program wheels and to effect sales operations (e.g. to generate proposals and insertion orders). Besides storing the content items themselves, the content library includes metadata indexed to content items—content tags—that can be used in searching for content items, in programming content items within program wheels, in generating proof of play reports and other sales reports, and for other purposes.

Content tags can be provided by a client company or other entity that supplies content items to the OOH network, or can be created by the OOH network in tagging third party content or original content created by the OOH network. In some cases, content tags for third party-supplied content items can be derived from metadata received with the content items, or can be derived from the content items themselves. An example of the latter is semantic analysis of text content items.

Examples of content tags include:
(1) Companies—Information on companies or entities associated with content items.
(2) Associated Brand—Brand(s) associated with content items.
(3) Content Genre—Subject matter categories; see Table 2 below for an illustrative set of content genres for the OOH network.
(4) Content-Management Types—Categories that aid network sales professionals in generating proposals, insertion orders, and sales reports, and that can be used in automated sales programs.
(5) Localization Tags—Location information concerning content items or a geographic plan to display content items.
(6) Repeat—Client instructions concerning the number of times in which given advertising or other content items are authorized to be played by the OOH network.
(7) Content-Integration Factors—Client instructions or OOH network-developed criteria used in programming decisions to integrate other content items with a given content item in programming.
(8) Restrictions—Client instructions or network-defined instructions limiting the scope of inclusion of content items in sales proposals and insertion orders, and in reserved inventory for automated sales programs.
   These contact tags are discussed individually below.

Companies. These companies can include client companies—e.g. companies that advertise products or brands on the OOH network 20, or advertising agencies of such companies. They can include companies that own individual network locations such as gasoline stations, as well as host companies that own a series of locations. Companies or entities also can include content providers.

Where the IMS 10 manages multiple OOH networks or networks in multiple venues, company data can track multiple entities such as advertisers and host companies that can be associated with an advertising campaign bridging the multiple networks or locations. For example as described below for example at Viewer Interactive Gas Station-based OOH Network, the owner of a convenience store chain may advertise its brand in the PUMPTOP TV network, in addition to other advertising within its stores.

Associated Brand. A brand can be associated with content items expressly (i.e. it is displayed when playing the content item) or by clear implication (e.g. a well known media brand can be evoked by a film clip). Brand associations can be useful in programming and in tracking advertising.

A brand type field can be used to differentiate different types of brands, and to track multiple brands associated with the same content item. A brand can be associated with creative elements of media (e.g. famous character, name of a film), or can identify companies that are associated with content items.

Gasoline station out-of-home advertising is largely brand advertising. On the other hand as discussed below at Viewer Interactive Gas Station-based OOH Network, product brands are more likely to be used on OOH network advertising within convenience stores.

Content Genre. These content genres are useful tools in inventory management and sales. For example, content genres can provide subject matter themes for combining advertising and non-advertising content (see content-management types below Table 2). Content genres can be assigned by the OOH network to content items including third-party provided items, or can be derived from metadata supplied by third parties. In addition the content management module 80 can store content tags based upon third-party content genre nomenclature, such as proprietary genre names used by content aggregators, as an accommodation to clients such as key advertisers.

TABLE 2
CONTENT GENRES

Animation
Art & Culture
Automotive
Business
Comedy
Cooking/Food
Entertainment news
Film
Financial
Green
Health/science
Hispanic
Home Garden
Music
Pets
Polls
Sports
Traffic
Travel
TV
Weather

Content management types. Exemplary content-management types include:
a) Advertising (promotional content created by or for client; network is paid by client)
b) Sponsored content (non-promotional content; network is paid by client typically in consideration of promotion ancillary to content)
c) Public Service Announcement
d) Licensed content (network pays display fee to content provider)
e) Original content (content created by the OOH network)
f) Public domain content
g) User Generated Content (UGC)
h) Station promotional content (promotional content of station owner or host)
i) Replacement content (content that fills unused parts of a program wheel).

Content management types can be used to manage inventory in automated sales programming. For example, a certain number of inventory slots can be reserved for User Generated Content (UGC), and other inventory slots can be reserved for local advertising.

Localization tags. Examples of localization tags include geo-coordinates, zip codes, or DMAs associated with content items. An exemplary application of localization tags is to identify different versions of content items for different locations.

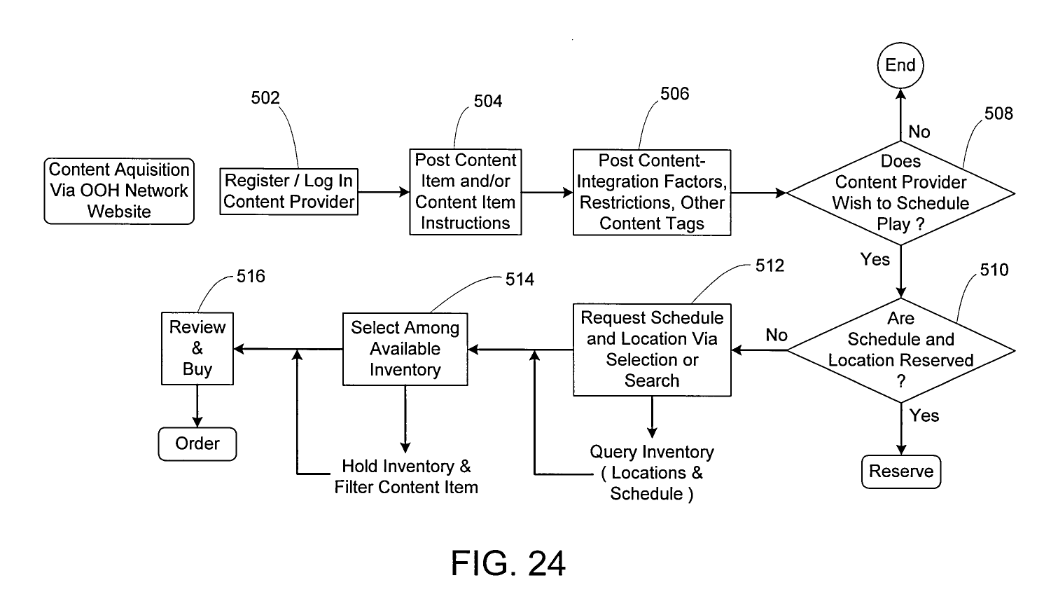

These localization tags are an example of content version tags used to facilitate the creation of program wheels, in this case to provide programming with different content items among a series of “content versions” depending on network location. An example of incorporation of localized content versions in program wheels is given below in a discussion of FIG. 24.

Repeat involves client or content provider instructions concerning the number of times in which given advertising or other content items are authorized to be played by the OOH network. For example there can be instructions about repeat play in different scheduled time periods, or different geographic locations, or limitations on repeat play of licensed content.

Content integration factors. Content integration factors may include positive integration factors, which favor integrating another content item with a given content item in a program wheel, and negative integration factors, which disfavor integrating another content item with a given content item. In one embodiment, there are three levels (strong, moderate, and weak) of positive and negative integration factors. A content item that fits a strong positive integration factor should be considered for close proximity to the given content item within a program wheel. On the other hand, another content item that fits a strong negative integration factor should probably not be included in the same program wheel as the given content item.

Content integration factors can take the form of field values of one or more content tag, in searchable form. For example a content integration factor may take the form of two or more content tag values expressed in Boolean logic. An example is an advertiser in the travel industry that instructs the OOH network on a strong negative content-integration factor for another advertisement in the same industry—(Content Type=Advertisement AND Content Genre=Travel). On the other hand, the advertiser could favor integration in the program wheel of a non-advertising Content Type in the same Content Genre—(Content Type=Public Service Announcement AND Content Genre=Travel).

Although content integration factors are normally used in integrating content items within a program wheel, they also can be used to integrate content items across multiple program wheels. An example is discussed below at Viewer Interactive Gas Station-based OOH Network.

Restrictions are client or content provider instructions or network-defined instructions limiting the scope of inclusion of content items in sales proposals and insertion orders, and in reserved inventory for automated sales programs. Repeat instructions and negative content integration factors are examples of such Restrictions. Restrictions can refer to inventory components such as scheduled time periods (permitted DayParts or days of the week) or geographic locations. See the IMS functional schematic of FIG. 4, which mentions geographic restrictions as part of the restriction function 77.

Restrictions data are employed in search queries of the content library 82 (FIG. 5) to limit the content items returned by such search queries as used in programming and sales operations. In search query selection criteria, restrictions may refer to content tags or may refer to other IMS data (as in a comparison of a repeat value with a play log that counts the number of OOH network plays of a content item).

As seen in FIG. 5, besides the content library 82, the second major function of the content management module 80 is the creation of program wheels, shown at 84. A program loop or program wheel comprises a set of content items that are programmed to play in given display zones and time segments within a set time interval, i.e. the duration of the program loop. The duration of a program loop often is chosen to match the typical dwell time of end users (display viewers) at the network location. For example, in a gasoline station OOH network an advantageous program loop duration is on the order of five minutes representing a typical gas fill-up interval.

FIG. 9 illustrates a program wheel 200 for a two-zone pump topper display, such as the layout 130 of FIG. 7. The program wheel's duration is 5 minutes and 30 seconds, divided into 22 time segments or wheel positions of 15 seconds each. The wheel 200 includes two columns 202 and 204, showing the content items assigned to wheel positions for two display areas, the skyscraper area 132 (FIG. 7) and the video area 134 (FIG. 7). In the program wheel 200 slots (i.e. given combinations of wheel position and display area), different content-management types are shown with different shading. The program wheel 200 shows at most wheel positions an advertising content item at one display area and a non-advertising content item at the other display area, so that viewers may never be presented advertisements only. The wheel's programming scheme also includes the reservation of four program wheel slots, i.e. both the skyscraper area 132 and video area 134 at wheel positions 11 and 22, for local promotional content of the gas station owner. In the content management types discussed above, these program wheel slots are reserved for the station owner to play station promotional content.

FIG. 10 shows a program wheel 220 for the three-zone topper display layout 150 of FIG. 8. The program wheel's duration is 4 minutes and 30 seconds, divided into 18 time segments or wheel positions of 15 seconds each. The wheel includes three columns 222, 224, and 226, showing the content items assigned to wheel positions for the three display areas—the vertical banner area 152 (FIG. 8) at the screen's left, the horizontal banner area 154 (FIG. 8) at the bottom, and the video area 156 (FIG. 8) at the right. In the program wheel slots, different content-management types are shown with different shadings. The program wheel shows at most wheel positions an advertising content item at the video display area 156 and non-advertising content items at the banner display areas 152 and 154, or advertising content items at the banner display areas 152 and 154 and a non-advertising content item at the video display area 156. Six program wheel slots, the vertical and horizontal banner areas and video area at wheel positions 9 and 18, are reserved for local promotional content of the gas station owner. As is the case in the two-zone program wheel 200 of FIG. 9, many of non-advertising content items in the certain areas of the program wheel 220 of FIG. 10 are web feeds that are displayed by the OOH network 20 in real time such as traffic, weather and news feeds.

The three columns 232, 234, and 236 for vertical replacement, horizontal replacement, and video replacement illustrate replacement content, i.e. preplanned content that fills unused parts of the program wheel 220 when advertising slots are not filled. For example if the Vertical Ad—2 slot is not filled or the Center Video Ad—1 slots is not filled, the content library includes replacement content to fill each of those slots.

The branding column 238 shows the OOH network brand that is displayed in the branding banner 158 at the top right of the layout of FIG. 8. As noted above this branding can change when managing an OOH network for a client with its own brand.

Although each of the program wheels of FIGS. 9 and 10 employs a given number of zones throughout the duration of the program wheel, it is possible for the display to switch between layouts during a given program wheel. For example the programming may switch from a three-zone layout as shown in FIG. 8, to a full-screen video as shown in FIG. 6.

The program wheel 220 of FIG. 10 illustrates the reservation of wheel positions for specialized programming purposes. In a first example, localized content slots at wheel position 16 illustrate the network location component of inventory slots, and variations in program wheels played at different network locations. For example, the program wheel of FIG. 10 would generally be identical at three different OOH network locations, the Los Angeles, San Diego and Palm Springs DMAs, and in particular the National Ad Video shown at slot 16 would be identical at these locations. However these program wheels would display different localized content items respectively for Los Angeles, San Diego and Palm Springs at the vertical and horizontal banner slots denoted as “Localization Banner—V” and “Localization Banner—H”. As a specific example of localized content versions, at the video slot in wheel position 16 the player displays a full motion video promoting a new book and announcing a nationwide book tour by the author. The vertical banner and horizontal banner slots at wheel position 16 display content items complementing the promotional video (“wrap around banner” or “ad wrap”), consisting of different announcements for the Los Angeles, San Diego and Palm Springs DMAs each with date and location of a local book tour event.

When an OOH network client imposes programming restrictions or provides special programming requests that integrate multiple content items, these requirements may create conflicts with other content management rules. The internal management system 10 (FIG. 1A) has prioritization criteria to deal with these conflicts, in which special-order programming may replace normal programming. For example, content items with content-management type “advertising” may be given priority over content-management type “public domain content”. Such conflicts can occur for example with synchronized programming, in which multiple display areas at the same wheel position are programmed for the same client. Synchronized programming is illustrated in the program wheel of FIG. 10 with the special-order “ad wrap” programming at wheel position 16. In this case, the IMS 10 had to remove from the program wheel 220 a web feed of sports content normally scheduled for the vertical banner slot at wheel position 16, replacing this sports content with the Localization Banner—Vertical.

### User Generated Content

Another example of specialized programming techniques illustrated in the program wheel of FIG. 10 is the use of reserved program wheel slots as part of an automated sales and inventory management scheme. Horizontal banner ad slots at wheel positions 1 and 10 are reserved for user generated content (UGC).

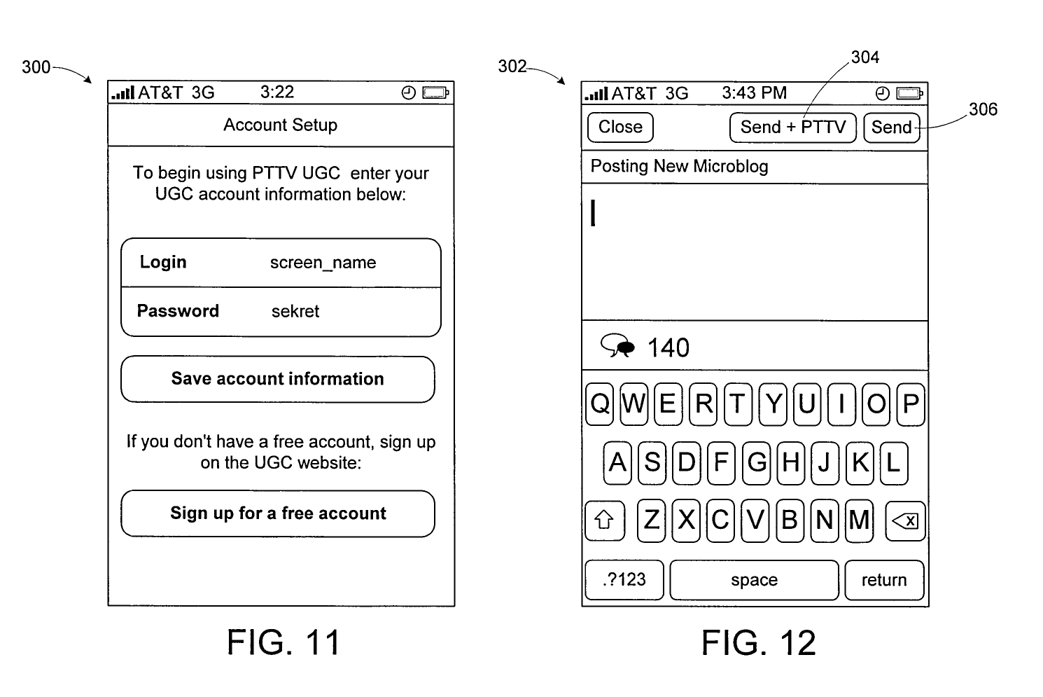

The following discussion illustrates the automated offer and ordering of OOH network inventory for insertion of UGC content items using a specialized handheld device application. The UGC comprises micro-blog posts such as 140-character “Tweets” of the TWITTER social networking and micro-blogging service. The OOH network 20 (FIG. 1B) displays these micro-blog posts in the horizontal banner zone of in the display layout of FIG. 8. FIGS. 11-23 illustrate a specialized application installed on a handheld device such as the IPhone® GSM cell phone of Apple Inc. This application allows a user to post a UGC item and to provide other inputs to insert the UGC item onto the OOH network 20. The OOH network's IMS 10 acts upon these inputs to offer available inventory slots and upon receiving a user order to insert the UGC item in one or more slot of the program wheel of FIG. 10 reserved for User Generated Content. Providing users with the ability to publish their UGC items at selected locations with selected scheduling is a novel application of digital signage technology that can be used for social networking, localized promotions, etc.

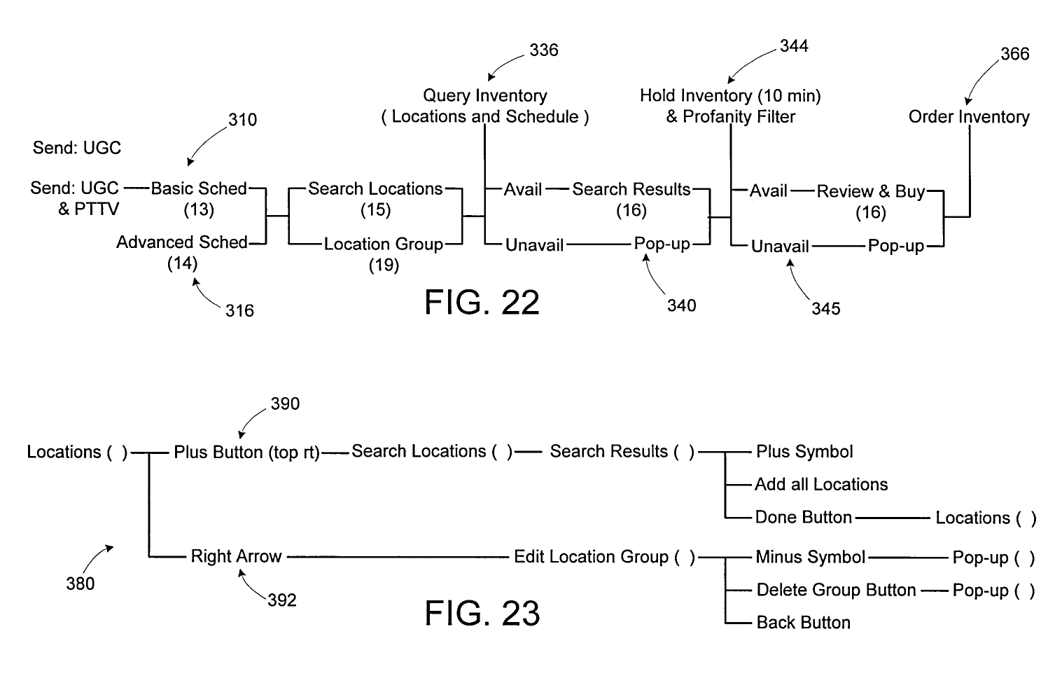

FIGS. 11-21 are screen shots of a handheld device application that allows a user to post a UGC item and to provide other inputs to place the UGC item (micro-blog post) on the OOH network 20 (FIG. 1B). FIG. 22 is a flow diagram of the application sequence illustrated in the screens of FIGS. 11-19, and the following discussion refers both to FIG. 22 and the corresponding views of FIGS. 11-19. In views not shown, the user installs the application, and in FIG. 11 the user can enter account information in an account setup screen 300. The information can be information previously entered for a UGC social networking host site (e.g. twitter.com), or the user can create a new account. User registration information of third party sites or devices, or personal information entered by a user when registering with the OOH network's UGC application, is one source of content tags for user generated content posted to the OOH network. For example, users' information on their activities and interests can be a source of content genre preferences in building a user profile.

FIG. 12 is a screen 302 in which a user can post a new micro-blog post, such as a 140-character (maximum) “Tweet” of the TWITTER social networking site. The buttons 304 and 306 shown at upper right of the screen 302 allow the user to choose whether to send the post only to the UGC host site (button 306), or to both the UGC host site and the OOH network (here called “PTTV”), with button 304. Referring to the flow diagram of FIG. 22, the following discussion assumes that the user selected Send UGC & PTTV (button 304).

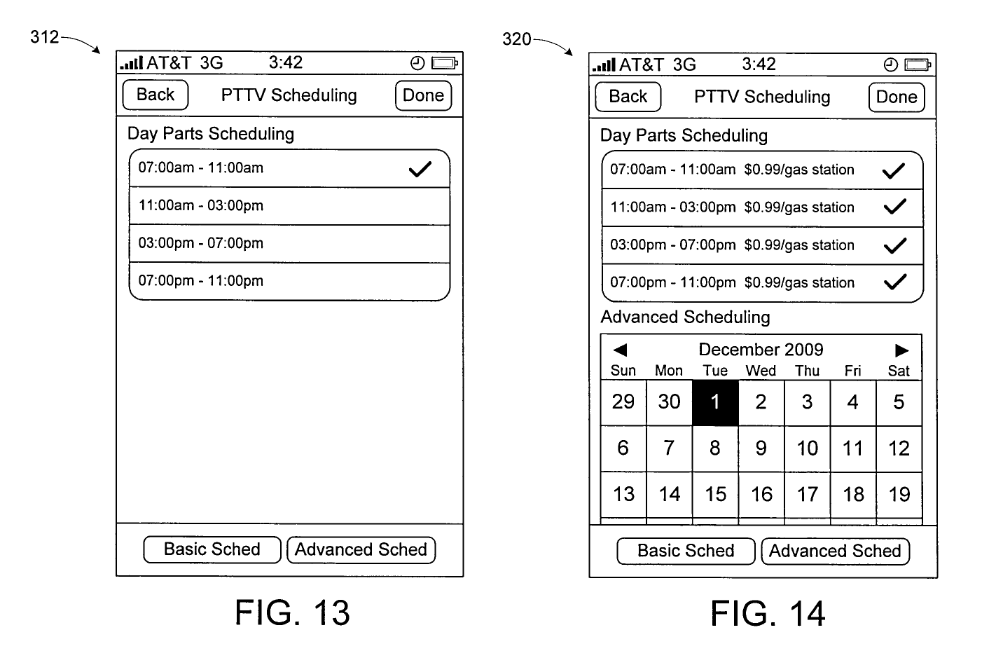

FIG. 13 shows the start of a sequence in which the user selects scheduling and location of the micro-blog post for publication by the OOH network 20 (FIG. 1B). FIG. 13 (a basic scheduling 310 shown in FIG. 22) shows a simple scheduling mode, a screen 312 in which the user selects the time of day (DayPart) during which the UGC item is to be scheduled, with the assumption that the network will select the first available day that offers available inventory at that DayPart once the user selects location.

FIG. 14 (advanced scheduling 316 in FIG. 22) shows a more comprehensive scheduling interface 320, in which the user selects one or more DayPart and one or more day for scheduling the UGC item. FIG. 14 illustrates pricing for the user's controlled scheduling in one or more selected scheduled time period, this pricing depending also on the number of OOH locations (gas stations) selected later. On the other hand, a simple mode of scheduling of a single first available OOH network slot as in FIG. 13 may assume scheduling at the closed OOH network location and may be free of charge. This could occur for example when a user views an OOH network display at a given location, and then decides to post a micro-blog post at that location (e.g. gas station).

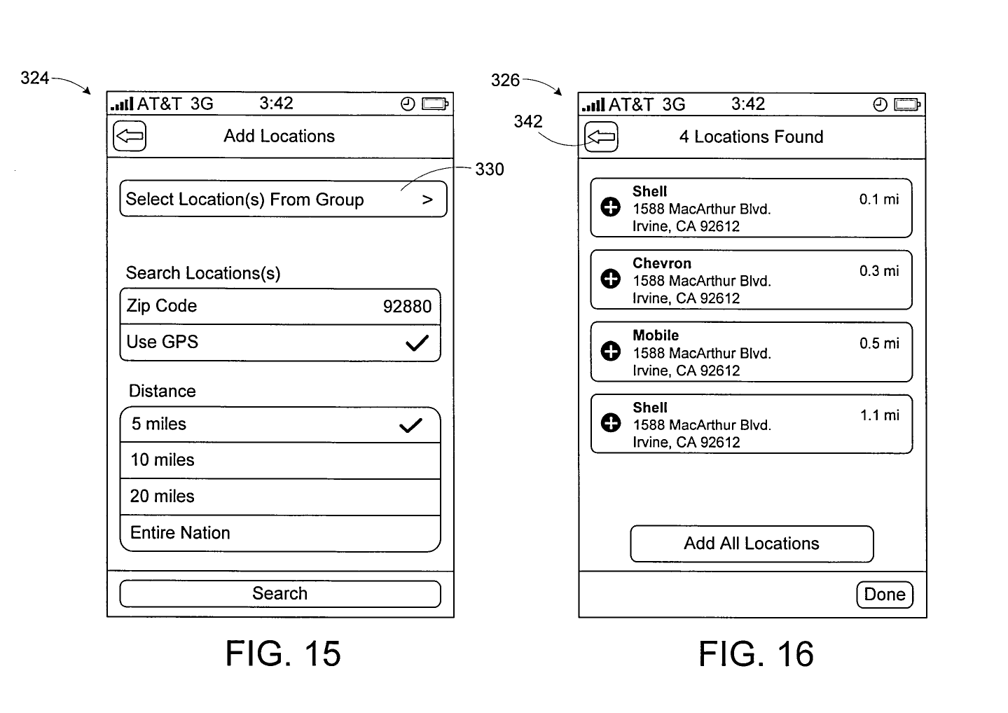

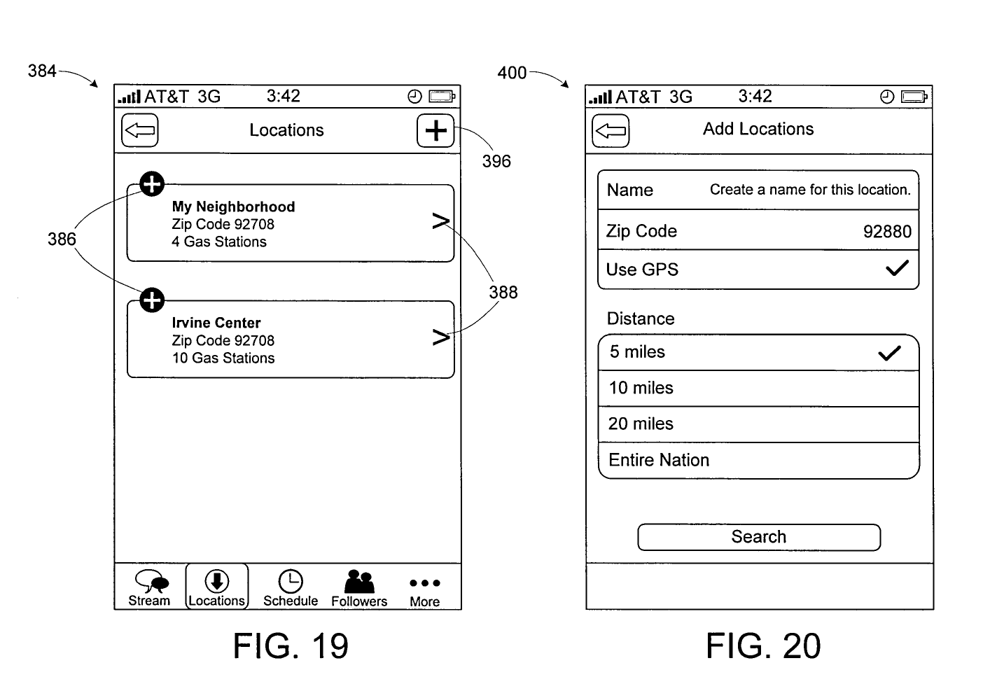

FIGS. 15 and 16 show screens 324 and 326 illustrating the sequence of steps for selecting locations in which the UGC item can be published by the OOH network consistent with the selected scheduling. As explained below in the discussion of FIGS. 19 and 20, the application permits the user to create “location groups” or groups of favored OOH network locations. FIG. 15 is the initial screen 324 for selecting locations, and first mode of selecting location shown at “Select Location(s) from Group” 330. This is for the user to select a previously created location group. This option is explained below in the discussion of FIG. 19. In the screen 324 of FIG. 15 the user also can select locations based a search for locations based upon chosen parameters. The search can be based upon a zip code entered by the user (e.g. a local zip code, or a remote zip code of friend or family). The search also can be centered on the GPS coordinates of the user's location for a GPS-enabled handheld device. The user can enter a distance (search radius) measured from the chosen point (GPS coordinates or zip code coordinates, the latter being standard longitude and latitude coordinates in a zip code database). Alternatively the user can select a nationwide search.

Once the user has entered a location group or location search parameters, as shown at reference number 336 in the flow diagram of FIG. 22, the IMS queries the OOH inventory module for available inventory based upon the schedule and location data entered by the user. Referring to FIG. 5, the OOH network inventory module 86 and the content management module 80 act automatically upon instructions received from the API of the datapuller 180, based in turn on data received from the handheld device. Thus in the present case the network inventory module 86 searches for inventory slots assigned to user generated content (FIG. 10), based upon the scheduling and locations preferences entered by the user.

FIG. 16 shows the screen 326 of the second stage of the user's selection of OOH network locations. The available locations based upon the location group chosen or search parameters entered (together with desired scheduling) are displayed. The user can select all displayed locations, or can select one or more location from those displayed. As indicated at reference number 340 in FIG. 22, if certain locations within the user's parameters are unavailable, the unavailable locations may be displayed in a pop up (not shown in the drawings). This gives the user the ability to press the left (back) arrow 342 in FIG. 16 to go back and enter new selection criteria (e.g. new scheduling) if a key desired location is unavailable based on the original criteria.

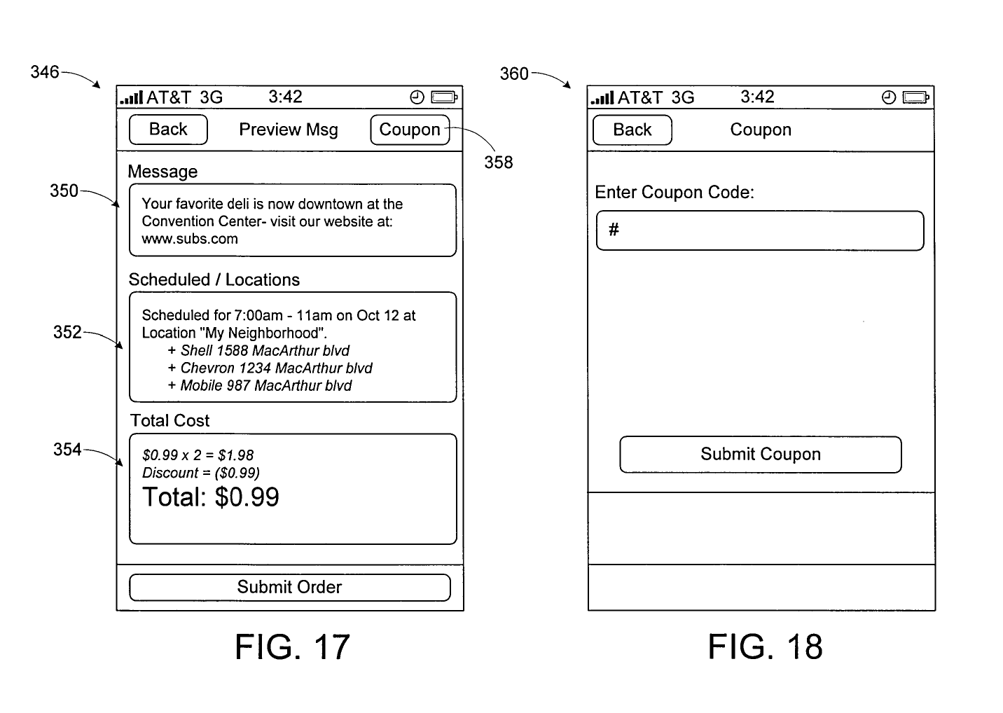

After the user confirms network locations, as shown at 344 in FIG. 22, the IMS 10 holds the inventory corresponding to the chosen scheduling and locations for a short period, e.g. ten minutes, to allow the user time to complete the transaction (purchase the OOH network placement(s)). Also at this time, the datapuller 180 (FIG. 5) passes the micro-blog message through a profanity filter. In one approach to profanity filtering, a message with offensive words will not be posted and (as indicated at 345 in FIG. 22) a pop-up, not shown, will indicate that placement on the UGC network is unavailable. Alternatively, the OOH network 20 can display a partially objectionable UGC message in an edited or redacted format to give the user the option to display the content in that format, and the modified format of the UGC message would be shown to the user in the preview screen 346 of FIG. 17.

The preview screen 346 of FIG. 17 displays information for the user to decide whether to finalize the transaction posting the UGC message to the OOH network. The micro blog message is displayed at top, such as in a message area 350. Below this the preview screen 346 displays the selected scheduling and locations in a scheduling and location area 352. In a bottom area 354 the screen 346 displays the transaction price and the basis for calculating that price. If the user has a coupon that can be applied against the price, she presses a coupon button 358. This causes the screen 360 of FIG. 18 to appear to permit the user to enter the coupon code. When the user is ready to complete the transaction, she presses the submit order button 364 in the screen 346. Thereupon the IMS inserts the content item into one or more inventory slot based upon the submitted order (reference number 366 in FIG. 22).

FIGS. 19 and 20, and the flow diagram 380 of FIG. 23, illustrate the user interface and processes for selecting and editing location groups, and for creating a new location group. In the screen of FIG. 14 if the user chooses “Select Location(s) from Group” 330, the application displays the screen 384 of FIG. 19, which displays previously created location groups. The screen 384 gives the user the option of selecting an existing location group by selecting the “+” button 386 associated with the group, or of editing that location by selecting the “>” button or selector 388 for that group. The buttons 386 and 388 correspond to the functions/processes 390 and 392 in FIG. 23, which provides additional details on editing content groups. In addition, the user can create a new location group by selecting the “+” button 396 at the upper right of FIG. 19. In the latter case the screen 400 of FIG. 20 appears. The user selects a name for the new location group, and enters search parameters (as discussed relative to FIG. 15) to generate locations to include in the new location group. A screen similar to the screen 326 of FIG. 16 appears, and the user can select given locations or all locations to include in the new location group.

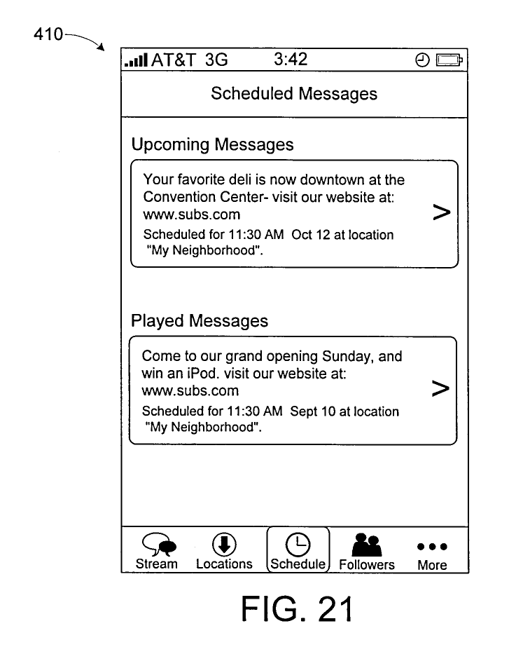

The screen 410 of FIG. 21 allows users to view micro-blog messages to be played by the OOH network under submitted orders, as well as previously played messages.

The exemplary handheld device application program of FIGS. 11-23 involves a particular type of user generated content, but the principles of this application can be extended to other types of user generated content as well as other content types. For example, the content items can be other types of audio-video media such as full motion videos and still photographs. The principles of this automated sales application are not limited to personal content such as social networking media, but also can be used in posting commercial content such as small business advertising. Other OOH network applications, such as templates for creating advertising items, can be used along with an automated sales application.

In the above UGC-posting application, all OOH network functions are either fully automated (sales/inventory management, content ingest, and content management) or bypassed (editing/reformatting). In a similar UGC-posting application in which full motion video content items are inserted in reserved program wheel slots, the network could retain network operator involvement in functions such as content ingest and editing/reformatting.

### Content Posting Via OOH Network Website

FIG. 24 shows a process 500 for ordering insertion of content items and metadata (content tags) to the OOH network 20 (FIG. 1B) through a content posting website designed and maintained by the network. The process 500 of FIG. 24 accesses the database management system of the OOH network, displaying a series of forms to guide users in posting various types of audio-visual content items, and related metadata. In a versatile website-based data acquisition process such as that of FIG. 24, the site structure and functionality can deal with content providers and content items fitting a variety of content management types. For example, a versatile content posting website can be used to order insertion of advertising, user generated content (UGC), and station promotional content. Such a content posting website also can be used by representatives of the OOH network 20 to post original content items. Alternatively, different content posting web sites can be provided by the OOH network 20 for different content management types in order to tailor each site to specific requirements of a given class of content providers. In an example, one web site serves providers of content items intended for PTTV screens, and another web site serves providers of content intended for C-store screens.

To initiate the content insertion process, at step 502 the content provider logs into the OOH network, and a new user first registers with the OOH network. OOH network login and registration can be used to associate the content provider with a given content management type and other user profile data. A return user may continue to build her profile. User profile data also may be derived from analysis of user-submitted content items and content tags.

The content posting website includes forms for posting content items to the OOH network, and for modifying or creating content items using the Content Generation function. At step 504 the content provider may post content items that comply with network production guidelines as described above. Alternatively the content provider may post non-compliant content items. A posted content item can be accompanied by instructions for modifying the content item or for additional content items based upon the posted item, such as a request to create content versions, or restrictions on content editing. Additionally, the OOH network can act upon content provider instructions in the absence of a content item. The content acquisition website can display content archetypes or templates to the content provider. For example a local advertiser can choose a content item template (such as a generic promotional clip) and can either customize the template or can provide instructions for reformatting or editing the template to create a local advertising content item.

At step 506 the content provider posts content tags using forms of the OOH website that guide the content provider inputting required or optional metadata. Content tags can describe attributes of the posted content item, can guide the OOH network in using the content item in programming, or can serve other purposes. For example content providers can post restrictions at this step. The content acquisition database can include special forms with look-up tables, help comments, and the like to guide users in submitting content tags such as content genres that involve standardized field values. It should be noted that content providers can use the OOH network content posting website to submit a content item to include in the content library without specifying scheduling of that content item, and it is not necessary that a posted content item be inserted in an inventory slot or onto a program wheel. Content provider instructions at step 506 can guide the OOH network in later inserting the posted content item into programming.

At step 508 the content posting website gives the content provider the opportunity to schedule OOH network play of the posted content item. If the content provider declines to schedule the content item within OOH network inventory, this ends the content posting process. Certain content providers such as gas station owners may have reserved inventory slots set aside for posted content without requiring scheduling instructions. For such content providers at step 510 the content posting website inserts each posted content item into one or more of the reserved inventory slots.

Steps 512, 514, and 516 correspond generally to steps of the UGC posting process for a handheld device illustrated in FIGS. 13-17. The content generation website may provide similar scheduling options by DayParts and calendar selections. Web pages similar to the handheld device application screens may be used for selecting one or more location to play posted content e.g. based upon a search of OOH network locations. On the other hand, depending on the content management type and other factors, different scheduling and location options can be provided in web pages of the content posting site. For example, in comparison to a provider of user generated content, a major advertiser may be more likely to schedule advertising across a set of DMAs, and the scheduling and location screens can be adapted accordingly.

As is the case with the handheld device application, the datapuller includes an application program interface with the data posting website that controls a two way data exchange with the OOH network including the network inventory module. The content posting process queries inventory for available slots after step 512, holds selected inventory slots pending ordering after step 514, and inserts a content item into inventory after a content provider makes a decision at step 516 to order such insertion. Details of the website-based posting method (such as scheduling options, length of time for which inventory is held, criteria for filtering content items, pricing and purchase options, etc.) may differ from the handheld device automated sales application described above.

### Viewer Interactive Gas Station-Based OOH Network

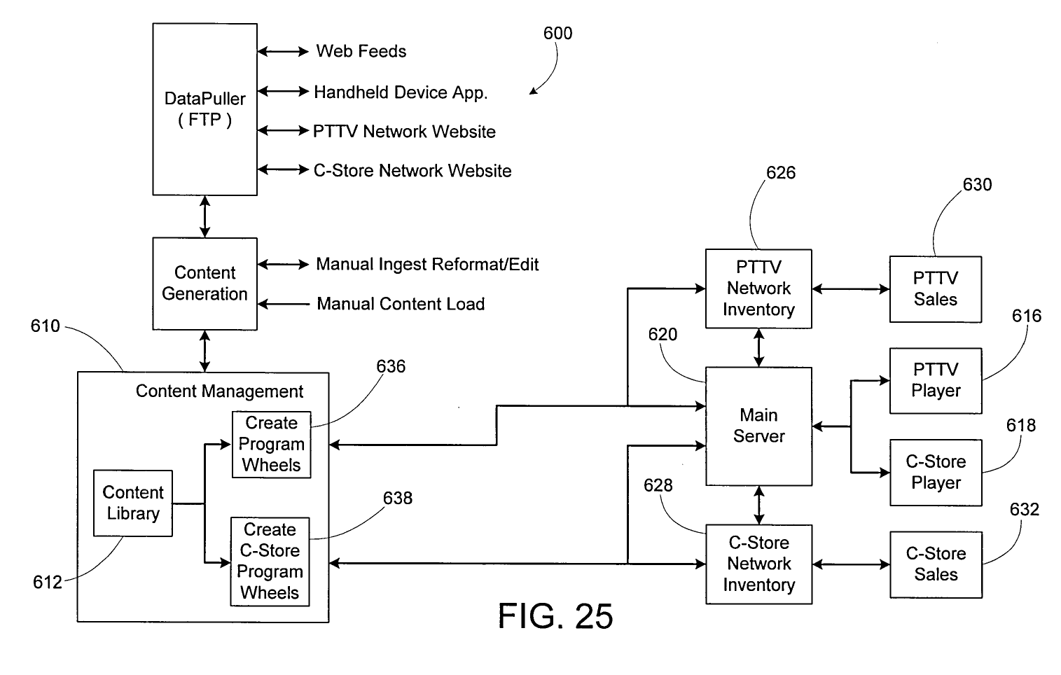

Principally the present patent disclosure describes a network of digital signage screens at gas pumps (digital toppers) in a gas station OOH network. However, given that many gasoline stations have associated convenience stores, there is an opportunity to use digital signage both at the gas pumps and within the convenience stores. FIG. 25 illustrates an OOH network architecture that includes networks of display screens/players at gas stations and at convenience stores associated with many of the gas stations. This architecture includes two different networks of display screens—a primary network of gas pump topper screens at gas stations, and a secondary network of in-store screens within convenience stores—both managed by the internal management system 600 of FIG. 25.

The architecture of FIG. 25 is similar to that of FIG. 5 and the present discussion focuses only on certain differences. The devices used by content providers to post content items to the OOH network can include for example a web site dedicated to the primary network of pumptop display screens (“PTTV”), and another web site dedicated to the secondary network screens (“C-Store,” short for “convenience store,” one example of an application). The content management module 610 includes a unified content library 612 serving both the PTTV screens 616 and the C-Store screens 618. Some examples and advantages of managing both screen networks from a single content library 612 are discussed below. An obvious advantage of a unified content library 612 is that content items can be used in either the PTTV or C-Store screens, but other advantages are noted below.

In the architecture of FIG. 25, the content management module 610 communicates with separate PTTV players 616 and C-store players 618 via a common main server 620. Separate inventory modules 626 and 628 track advertising and other content reserved for the PTTV digital signage network (primary network) versus the inventory of the C-Store digital signage network (secondary network). Separate sales modules 630 and 632 are provided for each type of digital signage. Distinct subassemblies 636 and 638 within the content management module 610 create programming for the PTTV display network and for the C-Store display network.

Gas pump advertising and C-Store advertising are substantially different environments with different commercial goals. PTTV programming tends to include brand advertising and content such as entertainment and public service announcements that improve the experience of captive viewers during the dwell time involved in gasoline fill up. Programming goals for screens within the C-store are substantially different. Product advertising will be more common. C-store owners do not favor program wheels with content that keeps patrons watching in-store screens for several minutes. There is no natural dwell time analogous to gas pump digital signage, and C-store owners generally prefer that patrons leave the C-store once they have made their purchases.

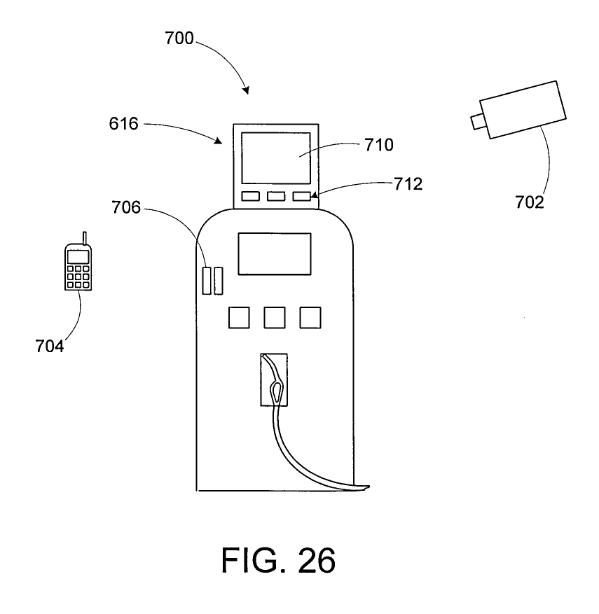

As seen in FIG. 26, the primary network may include a viewer-interactive device or multiple viewer-interactive devices 700 that perform one or more viewer interaction function. Viewer interaction functions include sensing one or more viewer at the topper display screen; characterizing viewer demographics and/or viewer psychographics; receiving viewer-input information; executing ecommerce transactions; and providing coupons to viewers for purchase of goods or services within associated convenience stores. Each viewer-interactive device sends viewer information to the main server, and also sends information to a local server that can deliver local content to the PTTV display as an alternative to programming from the main server. As will be apparent from the examples below, the viewer-interactive device can include hardware of the OOH network (such as a video camera 702), but also may rely upon hardware of a viewer (such as a mobile phone 704) or gas station (such as a credit card reader 706), in combination with OOH network software.

One type of viewer-interactive device is a video camera located in proximity to the PTTV display 616, with facial recognition software to interpret video images. As described above at Sales Function, the facial recognition software senses the presence and number of viewers at the gas pump topper display screen, and may measure the attention of given viewers to the display screen. The facial recognition software may characterize viewer demographics, such as gender, age, or ethnicity.

For viewers that pay for gasoline with a credit card, another type of viewer-interactive device is OOH network access to consumer data lists, which are mass repositories of public data used for marketing including for example names, addresses, demographic data and psychographic data.

It also will be appreciated that the display device 616 may be configured for viewer input. Examples of input devices include a touch screen 710 or push buttons 712.

The primary network may act upon viewer characteristics sensed by the viewer-interactive device, or may respond to viewer inputs to the viewer-interactive device, to display targeted content at the gas pump topper display screen. In order to facilitate viewer-targeted content, the PTTV display can be switched from the main server to a local server to receive locally stored content. This switch may be effected automatically upon sensing a particular user (e.g. via credit card scan), or by the viewer's entering in his cell phone or other viewer-interactive device a unique PTTV display screen identifier, which may be displayed at a marginal area of the screen. In one embodiment, the local server selects among a number of local program wheels based upon viewer demographics and psychographics. For example the local server can target a viewer identified as male (e.g. via a mobile phone user profile or facial recognition), sending the PTTV screen a C-store promotion for male personal care products.

Content tagging can be used to coordinate PTTV advertising with C-store advertising in the OOH network 600 of FIG. 25, drawing upon the unified content library 612. For example, an advertiser of branded consumer products can advertise its brand(s) (e.g. in cross-branding with a convenience store brand) at PTTV displays, as part of the same ad campaign in which a chain of convenience stores attached to the gas stations advertises the branded consumer products at its C-store digital screens. Associated Brand tagging and Content-Integration Factors can facilitate coordinated advertising across the primary and secondary networks.

It will be appreciated that the various details of viewer interaction or sensing described above may also be employed in out-of-home advertising locations other than an environment associated with a C-store.

Another example of a viewer-interactive device uses viewers' handheld devices such as mobile phones. Because of the limited dwell time for gas station users, typically around five minutes, the gas station hot spot engages users by offering them immediate, relevant benefits, herein called “benefit items”, via advertising on the gas pump topper display. Benefits that are readily available—that can be obtained at the pump, at an attached C-store, or at a nearby business establishment—are particularly suitable as they fit the psychology of a consumer “on the go”. Benefit items can motivate gas pump display viewers to join the OOH network, to provide user profile information to the OOH network, and to view targeted advertising at gas pump topper displays.

Benefit items may have economic value, such as discounts or coupons for advertiser goods and services advertised on the OOH network. Benefit items also include information for accessing advertised goods or services or other benefits displayed on a topper display screen, such as a local address or route map, or local contact information. A further type of benefit item is applications and services of the OOH network, such as the application for posting UGC on the OOH network described above in the disclosure section User Generated Content.

Benefit items also include the targeting of coupons, information, etc. to a particular user that has registered with the OOH network. Benefit items may be targeted when the OOH network recognizes a returning visitor whose hand held device is logged into the network. The gas pump topper display screen may display targeted programming, for example a program wheel that is selected based upon user demographic. In one embodiment, the gas pump topper display screen includes a unique identification number, and a user enters that number in her hand held device in order to display individualized programming at the gas pump topper display screen.

A gas station customer has only limited time, typically a dwell time of around five minutes, to communicate with the OOH network and receive an advertised benefit item. The gas pump topper display, in addition to the advertised benefit item, displays information that enables the user to rapidly access the OOH network using the handheld device in order to receive the benefit item, herein called “access information”. In one embodiment, the gas station hosts a wireless local area network (WLAN) that is open to customers of the gas station, i.e. a “hot spot”. The access information can include logon instructions for the WLAN, which may direct the user to a captive portal of the OOH network. Returning users may log onto the WLAN automatically and access an OOH network web page by opening the handheld device's browser.

In another embodiment, the access information comprises a bar code on the gas topper display screen that can be scanned using a mobile phone camera, such as a two dimensional bar code (or matrix code). Typically when the user scans the bar code with a camera of the handheld device, the device displays a web page identified by the matrix code. It should be noted that accessing the OOH network by scanning a matrix code does not require that a handheld device user be logged into the WLAN at the gas station.

There are a number of types of matrix code designed specifically for scanning by mobile camera phones. For example, the EZcode is a matrix code created by ETH Zurich. EZCode has been licensed to Scanbuy Inc. and is the subject of Scanbuy U.S. Pat. Nos. 7,287,696; 7,156,311; 7,296,747; 7,309,015; 7,245,780; 7,168,621; and 7,242,816. Another type is the High Capacity Color Barcode (HCCB) of Microsoft Corporation. HCCB is Microsoft's name for its proprietary technology of encoding data in a matrix code using clusters of colored triangles instead of the square pixels traditionally associated with matrix codes.

Another category of access information is security codes or passwords. For example the gas pump topper display can display a coupon code for users to enter in order to download a coupon to their handheld devices. Persons who can log into the WLAN (e.g. from a location neighboring the gas station) but who are not viewing the pump top display may not have the access code needed to download the coupon.

When a first time user logs into the OOH network, the network can display a Pumptop TV Mobile web page, which in addition to enabling the user to receive a benefit item may include a registration form to capture basic user information such as name, phone number and email address. Returning users can be directed to other pages of the Pumptop TV Mobile web site, e.g. pages specific to benefit item(s) associated with a current advertising promotion. Users who have provided demographics, activities or interests data can be directed to pages providing targeted benefits. Hand held device users at hot spots in high dwell time locations such as coffeehouses, delis and cafes often use their devices to browse the internet at their leisure. By contrast, the Pumptop TV Mobile web site is a captive portal designed to provide rapid user navigation and access to relevant benefits during limited dwell time at a gas station hot spot. Interested users may save a Pumptop TV Mobile bookmark for convenient return to this web site outside of OOH network hot spots.

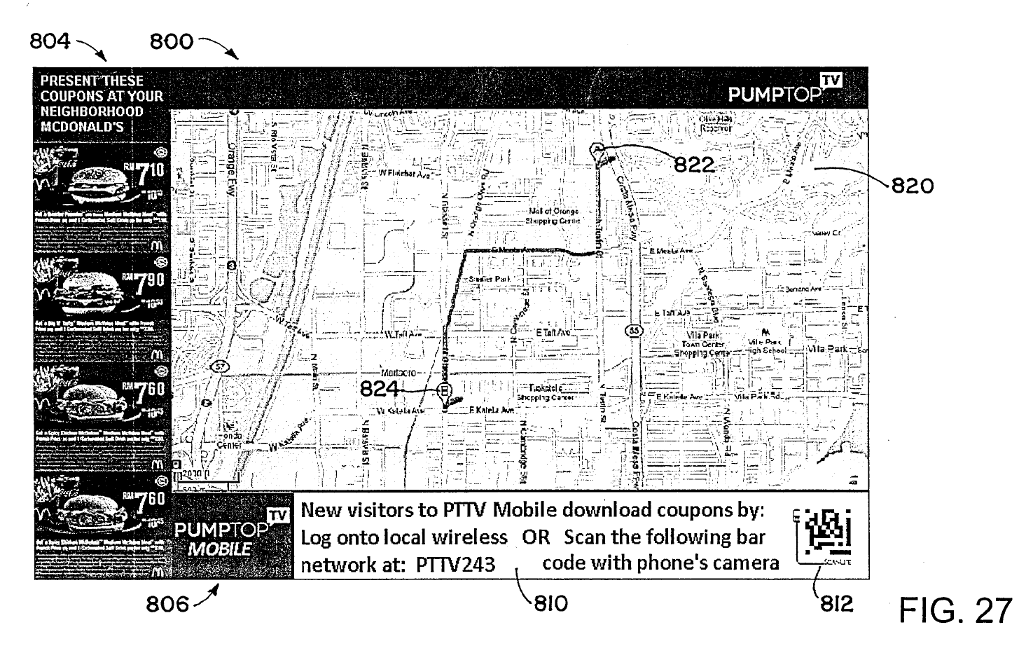

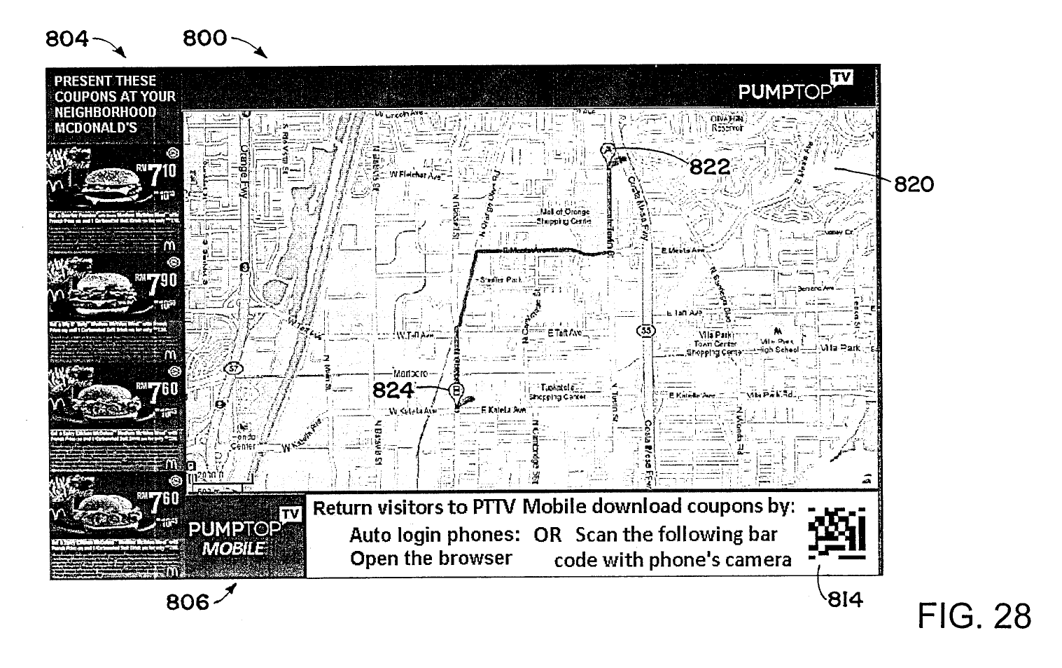

Synchronized programming at the gas pump topper display can display benefit items advertising and access information at different zones of the display. In the multi-zone display 800 of FIGS. 27 and 28, the vertical banner zone 804 includes advertising for a coupon promotion of a branded restaurant chain. The horizontal banner zone 806 displays access information. This zone 806 can display different access information to first time users and to returning users, for example in successive time segments during the program wheel. In FIG. 27, a first-time Pumptop TV Mobile user is given access information 808 for logging into the wireless network of that gas station, and the alternative access information of a matrix code 810. A user with a camera mobile device can scan the matrix code 810 to access a Pumptop TV Mobile web page (e.g. registration page) using mobile broadband communications. A returning Pumptop TV Mobile user (FIG. 28) that has a handheld device providing auto login to the WLAN network can open his browser to be directed to a Pumptop TV Mobile web page, as discussed above. A different matrix code 814 may be provided to direct the returning user to a different Pumptop TV Mobile web page.

Another zone 820 of a multi-zone display can provide additional information or additional benefit item(s) in synchronized programming. For example as shown in FIGS. 27 and 28 the PTTV network may incorporate a customized web mapping application. A route planner display seen in the video zone 820 indicates the route by automobile from the gas station location 822 to the location of the advertised local business 824. Directions information and/or route planner map can be downloaded to the viewer's handheld device along with coupon(s) for that local business.

Although the invention(s) has (have) been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of user placement of a content item for play on a location-based out of home advertising network, the method comprising:
providing a plurality of display screens each in a distinct geographic location, wherein each display screen plays content items during scheduled time periods, and wherein the content items include advertising content items and non-advertising content items;
maintaining on a network server of the out of home advertising network an inventory that includes inventory slots, wherein each inventory slot includes a given display screen location and a given scheduled time period, and wherein each inventory slot may be assigned a content item ordered to play at the given display screen location and a given scheduled time period;
receiving at the network server a user request from a user's electronic communications device to place a user content item in the out of home advertising network; and
operating a network user interface of the network to receive the user request, to automatically determine one or more inventory slot that is available to be ordered, and to automatically place an insertion order for the user content item from the user request into at least one inventory slot.

2. The method of claim 1,
wherein the display screens are capable of playing content items in multiple zones; and
wherein the operating includes the insertion order placing the user content item to play at a given zone for the at least one inventory slot.

3. The method of claim 1, wherein the content item that plays during the given scheduled time period is part of a program wheel that plays repeatedly during the given scheduled time period.

4. The method of claim 3, wherein the content item plays during one of a plurality of program wheel positions, wherein the program wheel positions comprise time segments within a duration of the program wheel.

5. The method of claim 4, wherein the display screens are capable of playing content items in multiple zones, and wherein each of the program wheel positions further comprises a given one of the multiple zones.

6. The method of claim 3, wherein a duration of the program loop corresponds to a typical dwell time of a viewer at the display screen.

7. The method of claim 1, further comprising receiving from the user one or more desired inventory slots in which the user content item is to be played.

8. The method of claim 7,
further comprising, in response to the receiving of the user request, sending from the network to the user one or more available inventory slots that are available to be ordered; and
wherein the receiving from the user the one or more desired inventory slots includes the one or more desired inventory slots selected from the one more available inventory slots.

9. The method of claim 8, further comprising the network holding the one or more available inventory slots for a period of time during which only the user can order the available inventory slots.

10. The method of claim 1, further comprising the network reserving a first group of the inventory slots as reserved inventory slots to be available for ordering by the user.

11. The method of claim 10, further comprising increasing or decreasing the volume of inventory slots in the first group of the reserved inventory slots.

12. The method of claim 10, further comprising the network reserving one or more additional group of inventory slots, wherein the first group and the one or more additional group are reserved for different categories of content items.

13. The method of claim 12, wherein the different categories of content items {are comprised of content management types, content genres, or combinations of content management types and content genres}.

14. The method of claim 10, wherein the content item that plays during the given scheduled time period is part of a program wheel that plays repeatedly during the given scheduled time period, and wherein the first group of inventory slots corresponds to one or more of a plurality of program wheel positions within the program wheel.

15. The method of claim 1, further comprising the step of automatically carrying out one or more network function on the user content item as a precondition to automatically place the insertion order for the user content item from the user request into the at least one inventory slot.

16. The method of claim 15, wherein the step of automatically carrying out one or more network function on the user content item comprises the step of filtering the user content item.

17. The method of claim 15, wherein the step of automatically carrying out one or more network function on the user content item comprises the step of reformatting the user content item.

18. The method of claim 15, wherein the step of automatically carrying out one or more network function on the user content item comprises the step of creating multiple versions of the user content item.

19. The method of claim 1, wherein the receiving the user request includes receiving the user request over a global computer network (the Internet).

20. The method of claim 1, wherein the receiving the user request includes receiving the user request from a wireless device.

21. A method for user interaction with a location-based out of home advertising network, the method comprising:
displaying on a display screen that is part of the network a benefit item and access information for communicating with the OOH network using a handheld device of a user, wherein the handheld device includes en electronic visual display;
sending a network screen to the handheld device, to be displayed on the electronic visual display of the handheld device, in response to use of the access information; and
sending the benefit item to the handheld device in response to a user input to the network screen.

22. The method of claim 21, wherein the benefit item includes an item having economic value.

23. The method of claim 22, wherein the item having economic value includes a discount or coupon.

24. The method of claim 21, wherein the benefit item includes information for accessing advertised goods and/or services.

25. The method of claim 21, wherein the benefit item includes a map.

26. The method of claim 21, wherein the benefit item includes an address.

27. The method of claim 21, wherein the benefit item includes contact information.

28. The method of claim 21,
wherein the display screen is a gas pump topper display screen; and
wherein the benefit item is displayed during dwell time of the user at a gas pump.

29. The method of claim 28, wherein the benefit item is usable at a business in close proximity to the gas pump.

30. The method of claim 28, wherein the benefit item is usable at a gas station that the gas pump is a part of.

31. The method of claim 30, wherein the benefit item is usable at a convenience store that is part of the gas station.

32. The method of claim 31,
wherein the network includes a wireless local area network (WLAN) that covers an area around the display screen; and
wherein the sending the network screen and the sending the benefit item includes sending over the WLAN.

33. The method of claim 21, wherein the access information includes a bar code displayed on the display screen.

34. The method of claim 33, wherein the bar code is a two-dimensional bar code.

35. The method of claim 33, wherein the network sends the network screen in response to scanning of the bar code by the user.

36. The method of claim 21, wherein the sending the network screen includes sending a new user registration screen, if the user is a new user.

37. The method of claim 36, wherein the new user registration screen prompts the user enter profile information.

38. The method of claim 37,
wherein the profile information includes one or more of demographic information and psychographic information; and
wherein the displaying includes displaying a benefit item that is selected on the basis of the one or more of demographic information and psychographic information.

39. The method of claim 21,
wherein the display screen is a multi-zone display screen; and
wherein the displaying includes displaying the benefit item and the access information in different zones of the multi-zone display screen.
